(19) United States
(12) Patent Application Publication
(10) Pub. No.: US 2025/0282032 A1
(43) Pub. Date: Sep. 11, 2025

(54) Wrench Socket

(71) Applicant: Cheng-Chia Peng, Taichung City (TW)

(72) Inventor: Cheng-Chia Peng, Taichung City (TW)

(21) Appl. No.: 19/074,575

(22) Filed: Mar. 10, 2025

(30) Foreign Application Priority Data
Mar. 8, 2024 (TW) 113108619

(51) Int. Cl. B25B 13/06

(52) U.S. Cl. CPC B25B 13/065

(57) ABSTRACT

A wrench socket, comprising a body having an axis, wherein the body is provided with a small-diameter section and a large-diameter section connected to the small-diameter section along the axis. The large-diameter section of the body has a side surface. A plurality of groove portions are arranged at intervals around the side surface of the large-diameter section. Each groove portion is formed on one end or both ends of the side surface along the axis. Each groove portion is tapered along the axis and has an included angle. Thereby, the wrench socket provides both anti-slip and anti-rolling capabilities, avoiding operational inconvenience and shortening operation time.

### FIELD OF THE INVENTION

The present invention relates to a socket, particularly to a wrench socket.

### DESCRIPTION OF THE RELATED ART

Conventionally, wrench sockets have a smooth exterior surface (see, for example, FIG. 1 of Taiwan Patent Publication No. TWM558688U, which discloses an exemplary embodiment). When operating a wrench socket, the surface must be gripped with the palm of the hand. However, natural sweat from the palm itself or oil stains adhered to the palm make it difficult to grip the smooth surface. Moreover, when the wrench socket is placed at a workplace (such as a machine), the smooth surface is prone to rolling. These issues cause the wrench socket to drop easily, resulting in operational inconvenience and prolonged operation time.

### SUMMARY OF THE INVENTION

An object of the present invention is to provide a wrench socket to solve the problems of the prior art as mentioned above.

According to one embodiment of the present invention, a wrench socket is provided, comprising: a body having an axis and a side surface, wherein a plurality of groove portions are arranged at intervals around the side surface, each of the plurality of groove portions is formed on the side surface between two ends of the body along the axis, and each of the plurality of groove portions is tapered along the axis and has an included angle.

The present invention, by virtue of the groove portions, provides the wrench socket with both anti-slip and anti-rolling capabilities, thereby avoiding operational inconvenience and shortening operation time.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF DRAWINGS

The above objects and advantages of the invention will become more readily apparent to those ordinarily skilled in the art after reviewing the following detailed description and accompanying drawings, in which:

FIG. 1 is a perspective view of a first embodiment of the wrench socket of the present invention.

FIG. 2A is a first cross-sectional view of the groove portion of the wrench socket of the present invention along the X direction.

FIG. 2B is a second cross-sectional view of the groove portion of the wrench socket of the present invention along the X direction.

FIG. 2C is a third cross-sectional view of the groove portion of the wrench socket of the present invention along the X direction.

FIG. 3A is a first cross-sectional view of the groove portion of the wrench socket of the present invention along the Y direction.

FIG. 3B is a second cross-sectional view of the groove portion of the wrench socket of the present invention along the Y direction.

FIG. 3C is a third cross-sectional view of the groove portion of the wrench socket of the present invention along the Y direction.

FIG. 4 is a schematic view showing the combination of the wrench socket of the present invention with a driving member and a driven member.

FIG. 5 is a schematic view showing the anti-rolling feature of the wrench socket of the present invention.

FIG. 6 is a schematic view showing the anti-slip feature of the wrench socket of the present invention.

FIG. 7 is a view showing a first operational state of the wrench socket of the present invention.

FIG. 8 is a view showing a second operational state of the wrench socket of the present invention.

FIG. 9 is a view showing a first variant of the wrench socket of the present invention shown in FIG. 1.

FIG. 10 is a perspective view of a second embodiment of the wrench socket of the present invention.

FIG. 11 is a front view and a rear view of the wrench socket shown in FIG. 10.

FIG. 12 is a left side view and a right side view of the wrench socket shown in FIG. 10.

FIG. 13 is a top view of the wrench socket shown in FIG. 10.

FIG. 14 is a bottom view of the wrench socket shown in FIG. 10.

FIG. 15 is a view showing a first variant of the wrench socket of the present invention shown in FIG. 10.

FIG. 16 is a view showing a second variant of the wrench socket of the present invention shown in FIG. 10.

FIG. 17 is a view showing a third variant of the wrench socket of the present invention shown in FIG. 10.

FIG. 18 is a perspective view of a third embodiment of the wrench socket of the present invention.

FIG. 19 is a front view and a rear view of the wrench socket shown in FIG. 18.

FIG. 20 is a left side view and a right side view of the wrench socket shown in FIG. 18.

FIG. 21 is a top view of the wrench socket shown in FIG. 18.

FIG. 22 is a bottom view of the wrench socket shown in FIG. 18.

FIG. 23 is a view showing a first variant of the wrench socket of the present invention shown in FIG. 18.

FIG. 24 is a view showing a second variant of the wrench socket of the present invention shown in FIG. 18.

FIG. 25 is a view showing a third variant of the wrench socket of the present invention shown in FIG. 18.

FIG. 26 is another perspective view of the wrench socket shown in FIG. 18.

FIG. 27 is a front view of the wrench socket shown in FIG. 26.

FIG. 28 is a rear view of the wrench socket shown in FIG. 26.

FIG. 29 is a left side view of the wrench socket shown in FIG. 26.

FIG. 30 is a right side view of the wrench socket shown in FIG. 26.

FIG. 31 is a top view of the wrench socket shown in FIG. 26.

FIG. 32 is a bottom view of the wrench socket shown in FIG. 26.

FIG. 33 is a view showing a fourth variant of the wrench socket of the present invention shown in FIG. 18.

FIG. 34 is a front view of the wrench socket shown in FIG. 33.

FIG. 35 is a rear view of the wrench socket shown in FIG. 33.

FIG. 36 is a left side view of the wrench socket shown in FIG. 33.

FIG. 37 is a right side view of the wrench socket shown in FIG. 33.

FIG. 38 is a top view of the wrench socket shown in FIG. 33.

FIG. 39 is a bottom view of the wrench socket shown in FIG. 33.

FIG. 40 is another perspective view of the wrench socket shown in FIG. 1.

FIG. 41 is a front view of the wrench socket shown in FIG. 1.

FIG. 42 is a rear view of the wrench socket shown in FIG. 1.

FIG. 43 is a left side view of the wrench socket shown in FIG. 1.

FIG. 44 is a right side view of the wrench socket shown in FIG. 1.

FIG. 45 is a top view of the wrench socket shown in FIG. 1.

FIG. 46 is a bottom view of the wrench socket shown in FIG. 1.

FIG. 47 is a perspective view of a fourth embodiment of the wrench socket of the present invention.

FIG. 48 is a front view of the wrench socket shown in FIG. 47.

FIG. 49 is a rear view of the wrench socket shown in FIG. 47.

FIG. 50 is a left side view of the wrench socket shown in FIG. 47.

FIG. 51 is a right side view of the wrench socket shown in FIG. 47.

FIG. 52 is a top view of the wrench socket shown in FIG. 47.

FIG. 53 is a bottom view of the wrench socket shown in FIG. 47.

FIG. 54 is a view showing a first variant of the wrench socket of the present invention shown in FIG. 47.

FIG. 55 is a front view of the wrench socket shown in FIG. 54.

FIG. 56 is a rear view of the wrench socket shown in FIG. 54.

FIG. 57 is a left side view of the wrench socket shown in FIG. 54.

FIG. 58 is a right side view of the wrench socket shown in FIG. 54.

FIG. 59 is a top view of the wrench socket shown in FIG. 54.

FIG. 60 is a bottom view of the wrench socket shown in FIG. 54.

FIG. 61 is a view showing a fifth variant of the wrench socket of the present invention shown in FIG. 18.

FIG. 62 is a front view of the wrench socket shown in FIG. 61.

FIG. 63 is a rear view of the wrench socket shown in FIG. 61.

FIG. 64 is a left side view of the wrench socket shown in FIG. 61.

FIG. 65 is a right side view of the wrench socket shown in FIG. 61.

FIG. 66 is a top view of the wrench socket shown in FIG. 61.

FIG. 67 is a bottom view of the wrench socket shown in FIG. 61.

FIG. 68 is a view showing a sixth variant of the wrench socket of the present invention shown in FIG. 18.

FIG. 69 is a front view of the wrench socket shown in FIG. 68.

FIG. 70 is a rear view of the wrench socket shown in FIG. 68.

FIG. 71 is a left side view of the wrench socket shown in FIG. 68.

FIG. 72 is a right side view of the wrench socket shown in FIG. 68.

FIG. 73 is a top view of the wrench socket shown in FIG. 68.

FIG. 74 is a bottom view of the wrench socket shown in FIG. 68.

FIG. 75 is a view showing a second variant of the wrench socket of the present invention shown in FIG. 1.

FIG. 76 is a front view of the wrench socket shown in FIG. 75.

FIG. 77 is a rear view of the wrench socket shown in FIG. 75.

FIG. 78 is a left side view of the wrench socket shown in FIG. 75.

FIG. 79 is a right side view of the wrench socket shown in FIG. 75.

FIG. 80 is a top view of the wrench socket shown in FIG. 75.

FIG. 81 is a bottom view of the wrench socket shown in FIG. 75.

FIG. 82 is a view showing a second variant of the wrench socket of the present invention shown in FIG. 47.

FIG. 83 is a front view of the wrench socket shown in FIG. 82.

FIG. 84 is a rear view of the wrench socket shown in FIG. 82.

FIG. 85 is a left side view of the wrench socket shown in FIG. 82.

FIG. 86 is a right side view of the wrench socket shown in FIG. 82.

FIG. 87 is a top view of the wrench socket shown in FIG. 82.

FIG. 88 is a bottom view of the wrench socket shown in FIG. 82.

FIG. 89 is a view showing a third variant of the wrench socket of the present invention shown in FIG. 47.

FIG. 90 is a front view of the wrench socket shown in FIG. 89.

FIG. 91 is a rear view of the wrench socket shown in FIG. 89.

FIG. 92 is a left side view of the wrench socket shown in FIG. 89.

FIG. 93 is a right side view of the wrench socket shown in FIG. 89.

FIG. 94 is a top view of the wrench socket shown in FIG. 89.

FIG. 95 is a bottom view of the wrench socket shown in FIG. 89.

FIG. 96 is a view showing a seventh variant of the wrench socket of the present invention shown in FIG. 18.

FIG. 97 is a front view of the wrench socket shown in FIG. 96.

FIG. 98 is a rear view of the wrench socket shown in FIG. 96.

FIG. 99 is a left side view of the wrench socket shown in FIG. 96.

FIG. 100 is a right side view of the wrench socket shown in FIG. 96.

FIG. 101 is a top view of the wrench socket shown in FIG. 96.

FIG. 102 is a bottom view of the wrench socket shown in FIG. 96.

FIG. 103 is a view showing an eighth variant of the wrench socket of the present invention shown in FIG. 18.

FIG. 104 is a front view of the wrench socket shown in FIG. 103.

FIG. 105 is a rear view of the wrench socket shown in FIG. 103.

FIG. 106 is a left side view of the wrench socket shown in FIG. 103.

FIG. 107 is a right side view of the wrench socket shown in FIG. 103.

FIG. 108 is a top view of the wrench socket shown in FIG. 103.

FIG. 109 is a bottom view of the wrench socket shown in FIG. 103.

FIG. 110 is a view showing a third variant of the wrench socket of the present invention shown in FIG. 1.

FIG. 111 is a front view of the wrench socket shown in FIG. 110.

FIG. 112 is a rear view of the wrench socket shown in FIG. 110.

FIG. 113 is a left side view of the wrench socket shown in FIG. 110.

FIG. 114 is a right side view of the wrench socket shown in FIG. 110.

FIG. 115 is a top view of the wrench socket shown in FIG. 110.

FIG. 116 is a bottom view of the wrench socket shown in FIG. 110.

FIG. 117 is a view showing a fourth variant of the wrench socket of the present invention shown in FIG. 47.

FIG. 118 is a front view of the wrench socket shown in FIG. 117.

FIG. 119 is a rear view of the wrench socket shown in FIG. 117.

FIG. 120 is a left side view of the wrench socket shown in FIG. 117.

FIG. 121 is a right side view of the wrench socket shown in FIG. 117.

FIG. 122 is a top view of the wrench socket shown in FIG. 117.

FIG. 123 is a bottom view of the wrench socket shown in FIG. 117.

FIG. 124 is a view showing a fifth variant of the wrench socket of the present invention shown in FIG. 47.

FIG. 125 is a front view of the wrench socket shown in FIG. 124.

FIG. 126 is a rear view of the wrench socket shown in FIG. 124.

FIG. 127 is a left side view of the wrench socket shown in FIG. 124.

FIG. 128 is a right side view of the wrench socket shown in FIG. 124.

FIG. 129 is a top view of the wrench socket shown in FIG. 124.

FIG. 130 is a bottom view of the wrench socket shown in FIG. 124.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

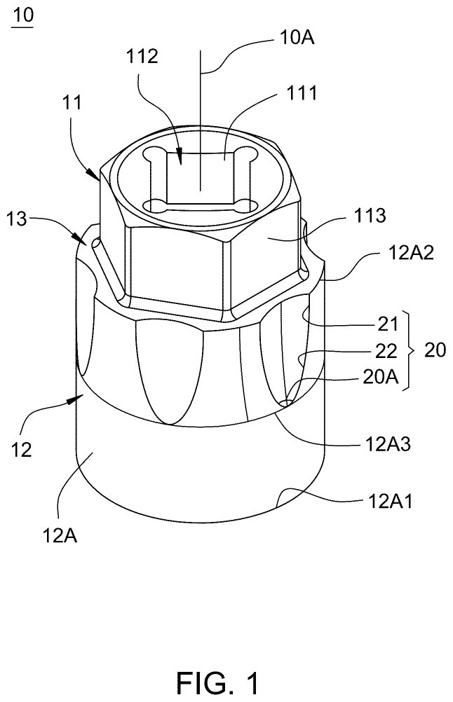

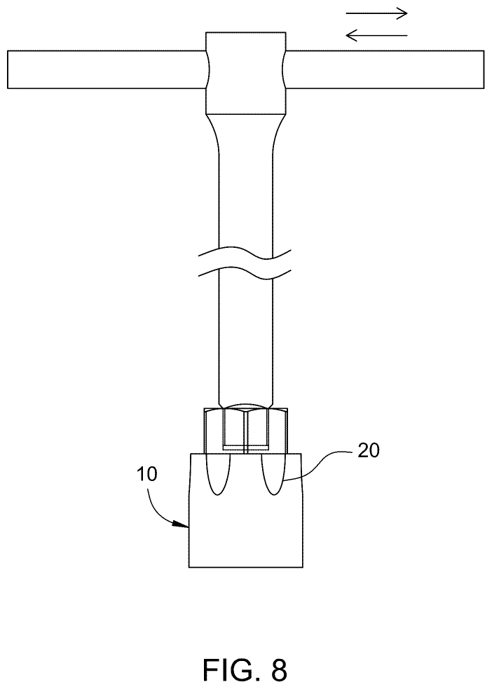

Referring to FIGS. 1 to 130, the present invention provides a wrench socket including a body 10 in a first embodiment (refer to FIGS. 1 to 9), which will be described as follows. The body 10 is formed by forging, but is not limited to forging. The body 10 has an approximately cylindrical appearance.

Referring to FIG. 1, the body 10 has an axis 10A. The body 10 is provided axially along the axis 10A with a small-diameter section 11 and a large-diameter section 12 connected to the small-diameter section 11. The maximum outer diameter of the small-diameter section 11 is smaller than the maximum outer diameter of the large-diameter section 12. Furthermore, a connecting section 13 is provided between the small-diameter section 11 and the large-diameter section 12 to connect the sections having different outer diameters. The connecting section 13 has a connecting angle, which may be selected from curved corner, chamfered corner, and right angle, or combinations thereof. The inclined angle includes acute angle (greater than 0° and less than) 90° and obtuse angle (greater than 90° and less than 180°).

Referring to FIG. 1, the small-diameter section 11 is provided with a force-receiving part 111 from one end face of the body 10 along the axis 10A, and has a force-receiving opening 112 recessed toward the large-diameter section 12. The large-diameter section 12 is provided with a force-applying part 121 from another end face of the body 10 along the axis 10A, and has a force-applying opening 122 recessed toward the small-diameter section 11.

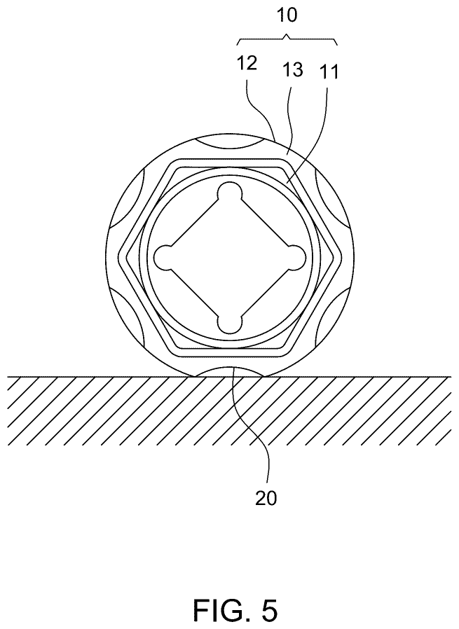

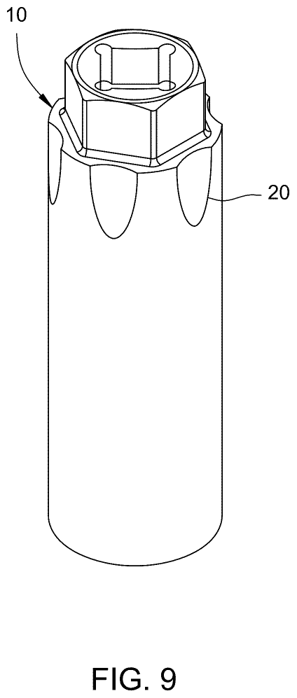

The force-receiving part 111 and the force-applying part 121 may be non-communicating slots or may be communicating holes, but are not limited to slots or holes. FIG. 5 of Taiwan Patent Publication No. TWM558688U shows an example of slots. FIG. 9 of Taiwan Patent Publication No. TWM558688U and FIG. 1 of Taiwan Patent Publication No. TW249372U show examples of holes.

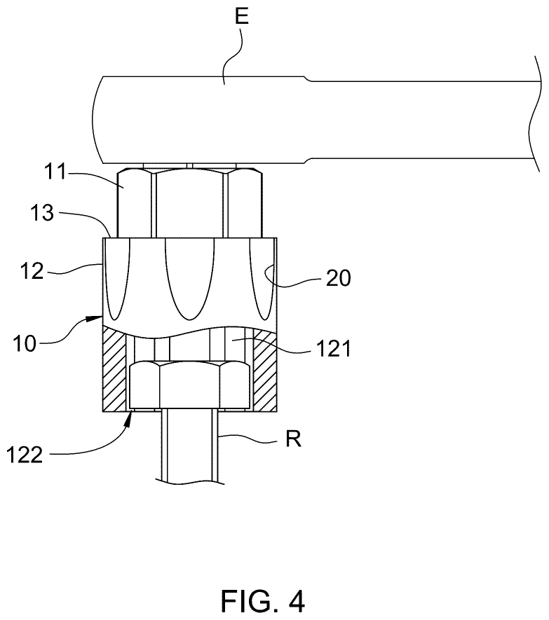

Referring to FIGS. 1 and 4, the force-receiving part 111 combines with a driving member E through the force-receiving opening 112. One example of the driving member E may be a wrench, but is not limited to a wrench. The force-applying part 121 combines with a driven member R through the force-applying opening 122. One example of the driven member R may be a screw, but is not limited to a screw. When the user applies force to the driving member E, the force-receiving part 111 of the small-diameter section 11 rotates under force, causing the force-applying part 121 of the large-diameter section 12 to apply force to the driven member R, thereby causing the driven member R to rotate under force.

Referring to FIG. 1, the outer wall of the large-diameter section 12 of the body 10 has a side surface 12A surrounding the axis 10A. A plurality of groove portions 20 are arranged at intervals around the side surface 12A of the large-diameter section 12. Each groove portion 20 is formed on one end of the side surface 12A along the axis 10A. The groove portion 20 is approximately bullet-shaped.

Referring to FIG. 1, the side surface 12A further defines a first end 12A1 and a second end 12A2. Each groove portion 20 starts from the second end 12A2 (that is to say, each groove portion 20 contacts the second end 12A2) and terminates before the first end 12A1 (that is to say, each groove portion 20 does not contact the first end 12A1). A dividing line 12A3 is further defined between the first end 12A1 and the second end 12A2. The dividing line 12A3 may be a midline, with the midline being equidistant from the first end 12A1 and the second end 12A2. Each groove portion 20 further terminates at the dividing line 12A3 (that is to say, each groove portion 20 contacts the dividing line 12A3) or terminates before the dividing line 12A3 (not shown, that is to say, each groove portion 20 does not contact the dividing line 12A3).

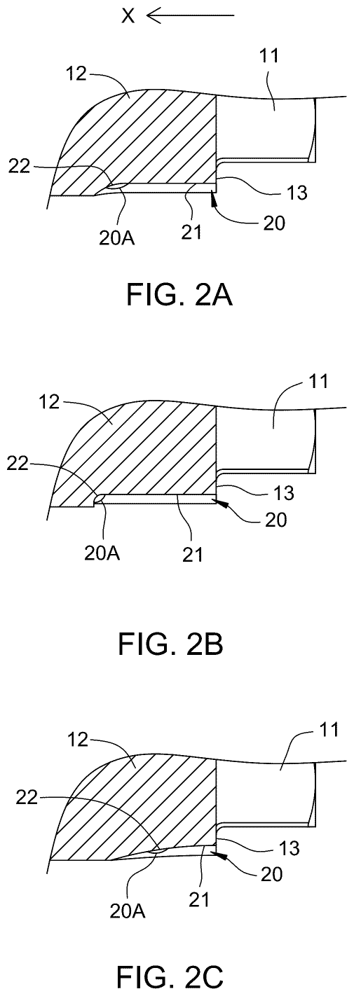

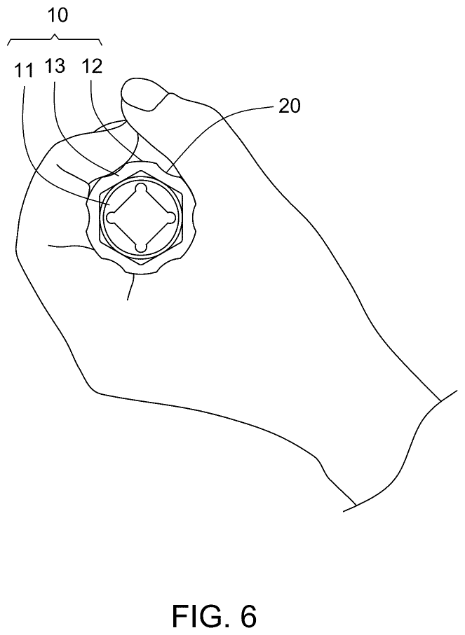

Each groove portion 20 is gradually tapered along the axis 10A and has an included angle 20A (refer to FIG. 1). Each groove portion 20 is gradually tapered along the axis 10A from the front end toward the rear end, and has at the rear end an included angle 20A that becomes narrower in width (refer to FIG. 1, viewed axially from the front end toward the rear end) and shallower in depth (refer to FIG. 2, viewed axially from the front end toward the rear end). When viewed in cross-section along the X direction, the included angle 20A may be selected from rounded corner (refer to FIGS. 2A and 2B), curved corner (refer to FIG. 2C), and chamfered corner, or combinations thereof. The chamfered corner includes acute angle and obtuse angle to adapt to different usage requirements. The groove portion 20 provides the body 10 with anti-rolling capability (refer to FIG. 5) and anti-slip capability (refer to FIG. 6). Different angles of the included angle 20A of the groove portion 20 produce different effects. For example, acute angle can enhance anti-slip effect in specific directions; right angle provides definite anti-rolling stop points; obtuse angle provides larger contact area; rounded corner can reduce stress concentration; curved corner provides progressive anti-slip effect. The present invention may also employ combinations of the above angle types. For example, the groove portion 20 may employ different angle designs at different positions, thereby providing anti-slip and anti-rolling effects under different working conditions.

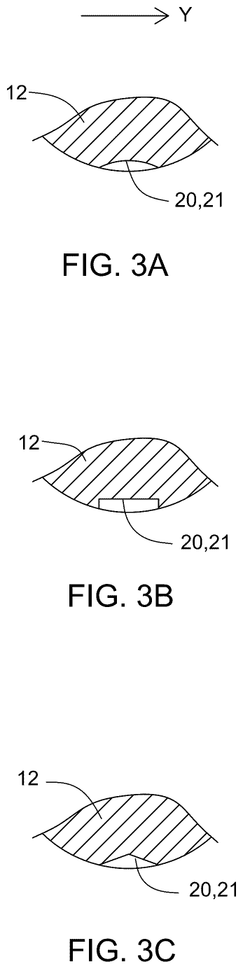

Referring to FIGS. 1 and 2, each groove portion 20 further forms, along the axis 10A from the front end toward the rear end, a straight section 21 and a tapered section 22 connecting to the straight section 21. The tapered section 22 has an included angle 20A. When viewed in cross-section along the Y direction, the straight section 21 may be selected from arc-shaped (refer to FIG. 3A), U-shaped (refer to FIG. 3B), and A-shaped (refer to FIG. 3C), or combinations thereof. The Y direction and the X direction intersect each other, and further, the Y direction and the X direction are orthogonal or perpendicular to each other.

Each groove portion 20 of the large-diameter section 12 may also be formed on another end of the side surface 12A along the axis 10A. Each groove portion 20 may also start from the first end 12A1 (not shown, that is to say, each groove portion 20 contacts the first end 12A1) and terminate before the second end 12A2 (not shown, that is to say, each groove portion 20 does not contact the second end 12A2). Each groove portion 20 further terminates at the dividing line 12A3 (not shown, that is to say, each groove portion 20 contacts the dividing line 12A3) or terminates before the dividing line 12A3 (not shown, that is to say, each groove portion 20 does not contact the dividing line 12A3).

Each groove portion 20 of the large-diameter section 12 may also be simultaneously formed at both ends of the side surface 12A along the axis 10A. The starting and terminating positions of each groove portion 20 are as described above. It should be noted that the groove portions 20 at the two ends of the side surface 12A do not contact each other.

The small-diameter section 11 may also have another force-receiving part 113 provided on a side surface of the small-diameter section 11 surrounding the axis 10A (refer to FIG. 1). The force-receiving part 113 combines with another driving member that has a driving opening (refer to the example shown in FIG. 5 of Taiwan Patent Publication No. TWM243300U). The driving member may be a wrench. The force-receiving parts 111 and 113 may be simultaneously provided on the small-diameter section 11 (refer to FIG. 1), or alternatively, only one of the force-receiving parts 111 and 113 may be provided on the small-diameter section 11 (not shown, that is to say, selecting either force-receiving part 111 or 113).

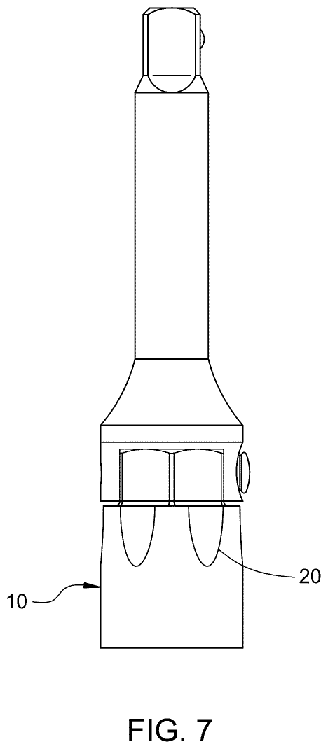

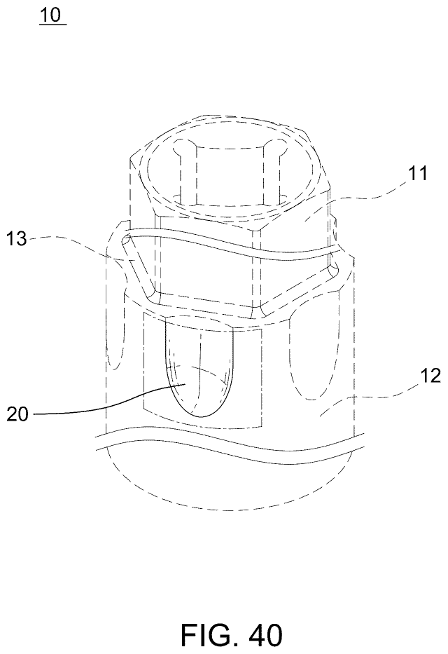

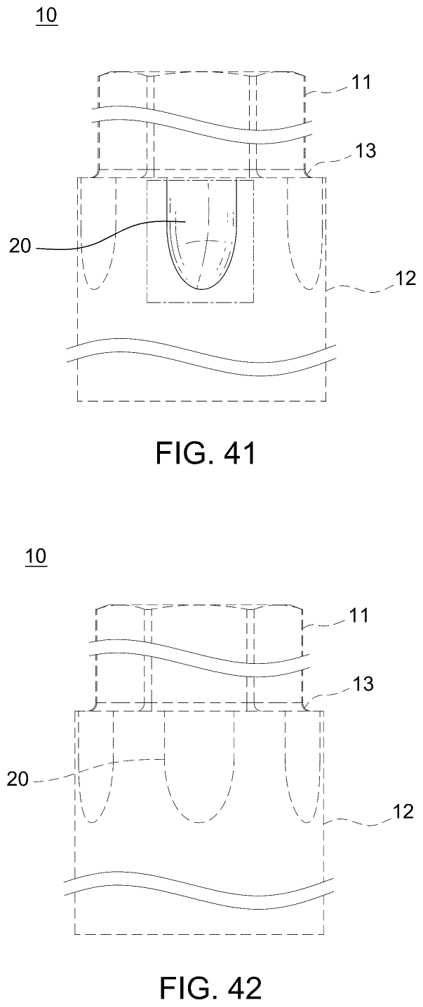

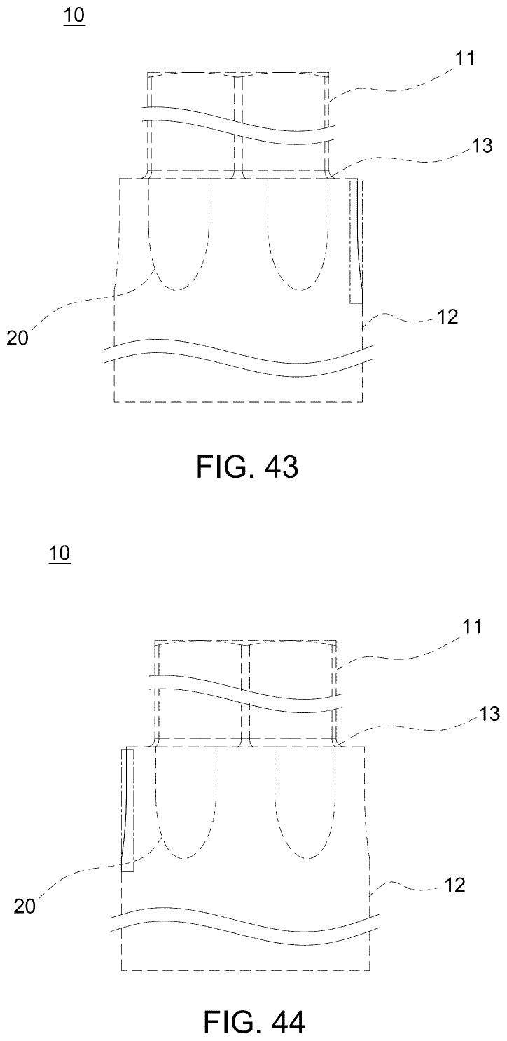

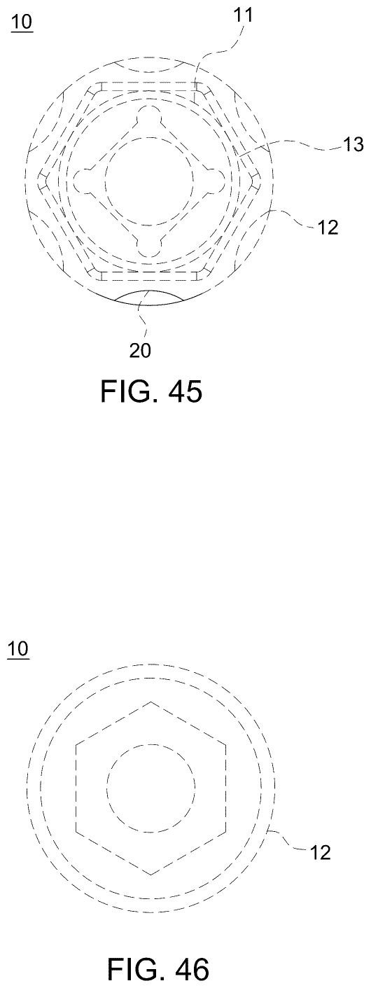

FIGS. 7 to 9 show different operational states of the body 10 and different variant configurations of the body 10 of the first embodiment. The first embodiment may also refer to FIGS. 40 to 46.

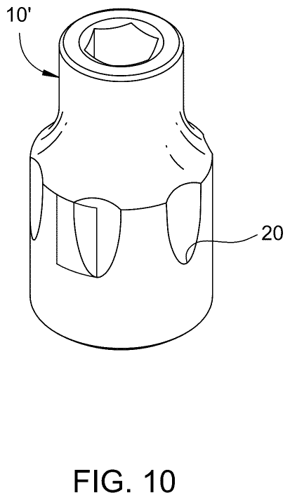

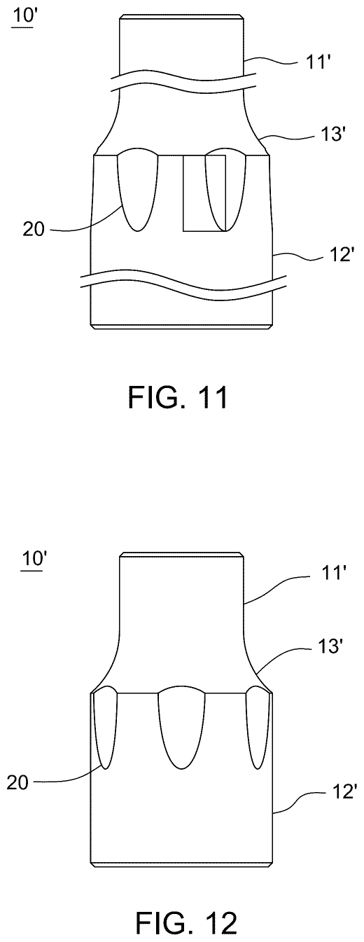

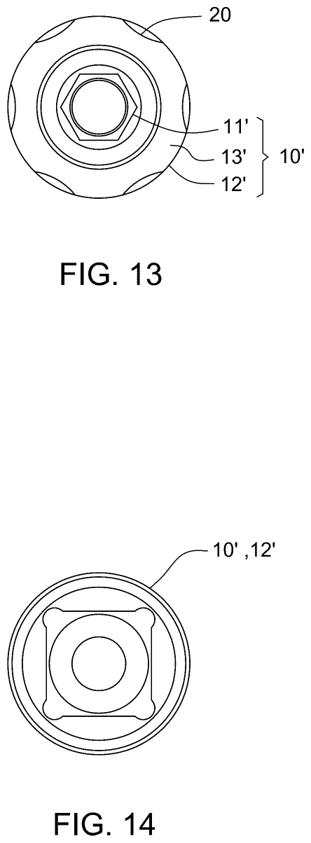

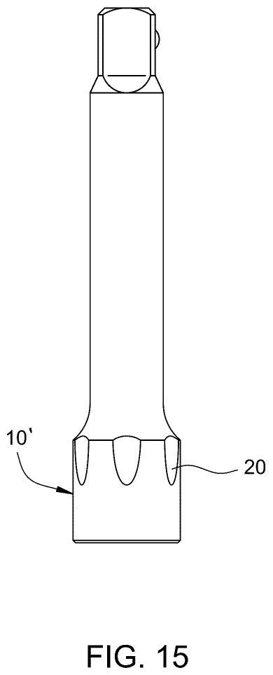

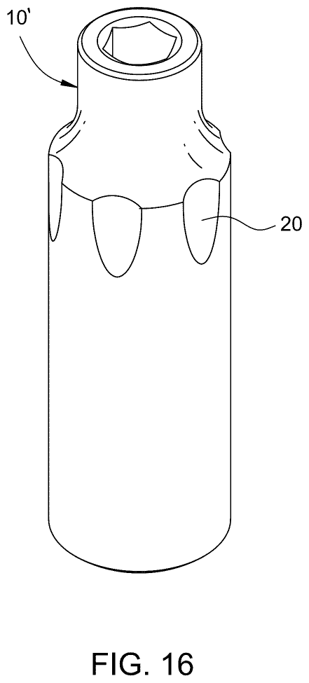

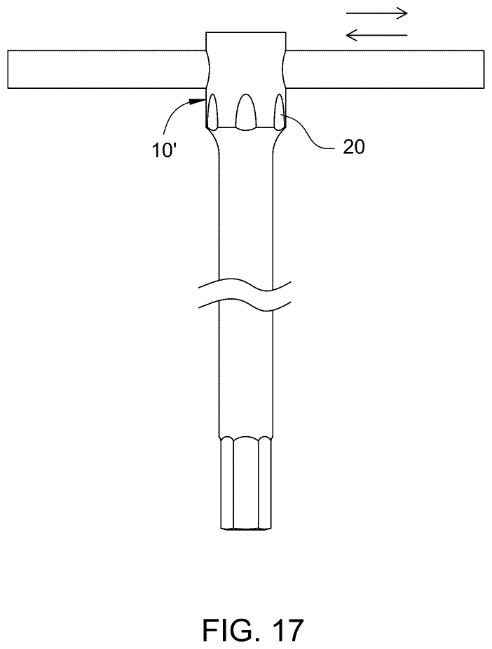

Referring to FIGS. 10 to 17, the second embodiment is described as follows. Refer to FIG. 10: the differences from the first embodiment lie in the variations of the small-diameter section 11′, large-diameter section 12′, and connecting section 13′ of the body 10′. The groove portion 20 maintains an approximately bullet-shaped configuration. The body 10′ in perspective view (refer to FIG. 10), the body 10′ in front view (refer to FIG. 11, with the rear view being identical to the front view, thus omitted), FIG. 11 uses break lines to indicate that the small-diameter section 11′ and large-diameter section 12′ have consistent shape, structure, or regular variation along their length. In left side view (refer to FIG. 12, with the right side view being identical to the left side view, thus omitted), in top view (refer to FIG. 13), in bottom view (refer to FIG. 14). Additionally, different variant configurations of the body 10′ incorporate the approximately bullet-shaped groove portion 20 (refer to FIGS. 15, 16, 17).

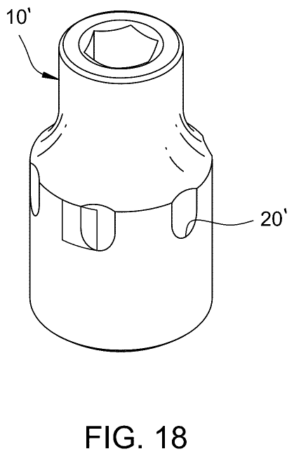

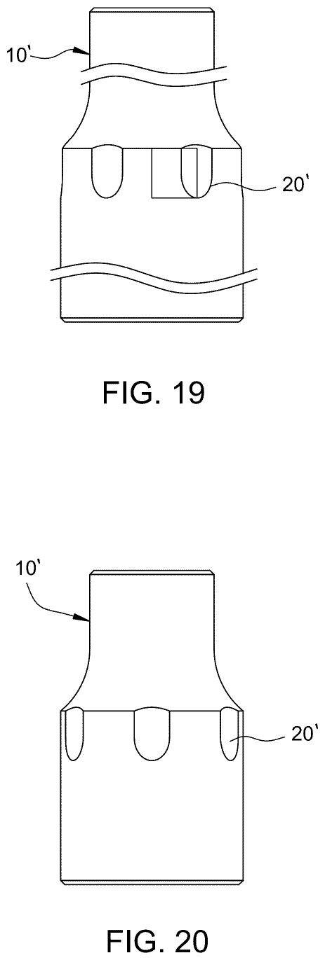

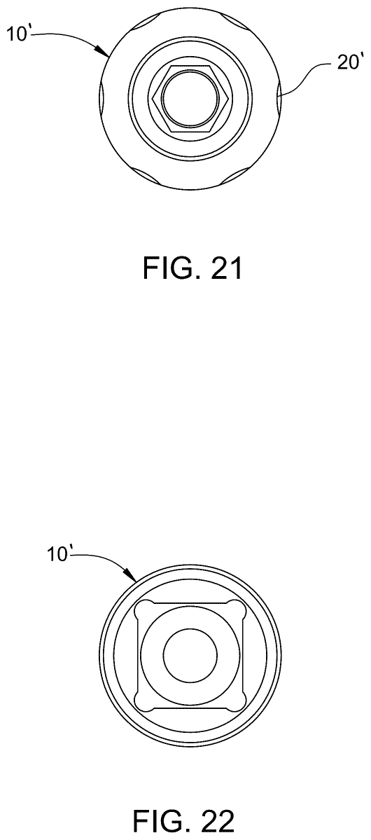

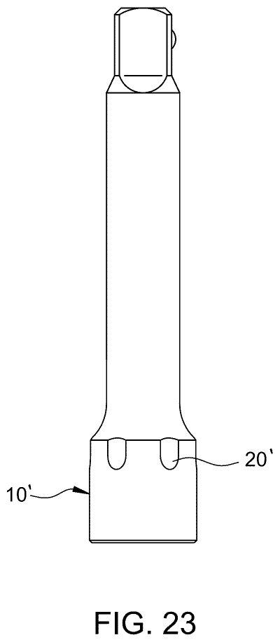

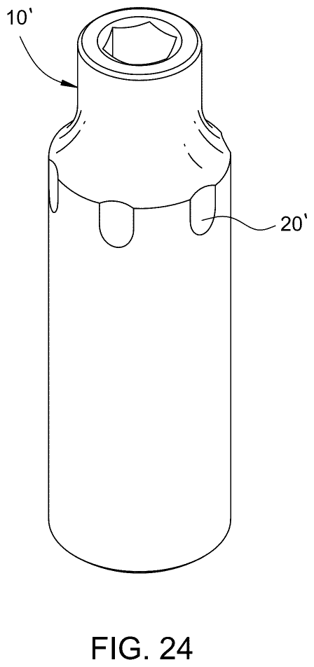

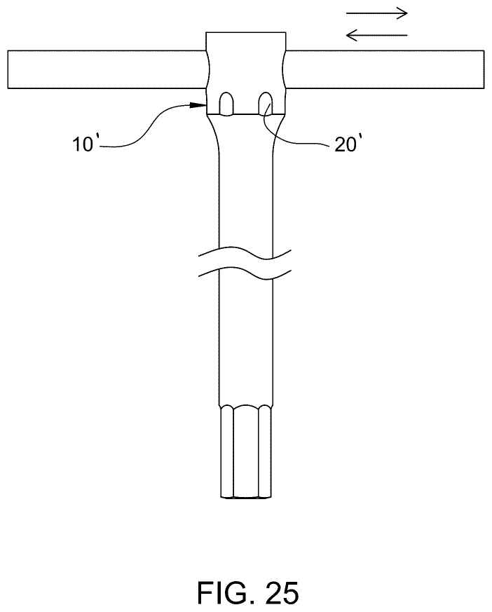

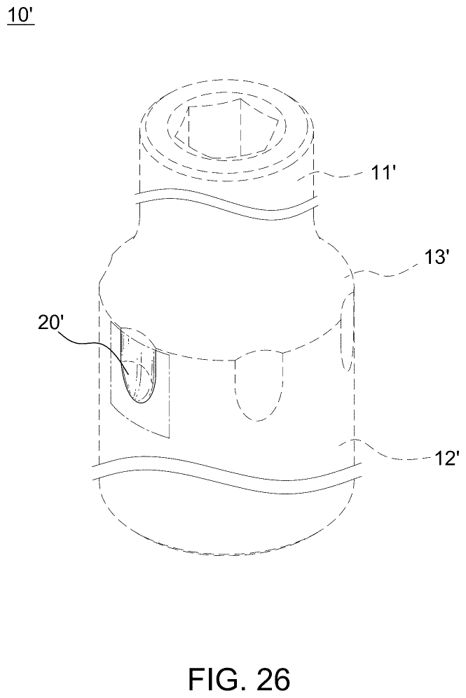

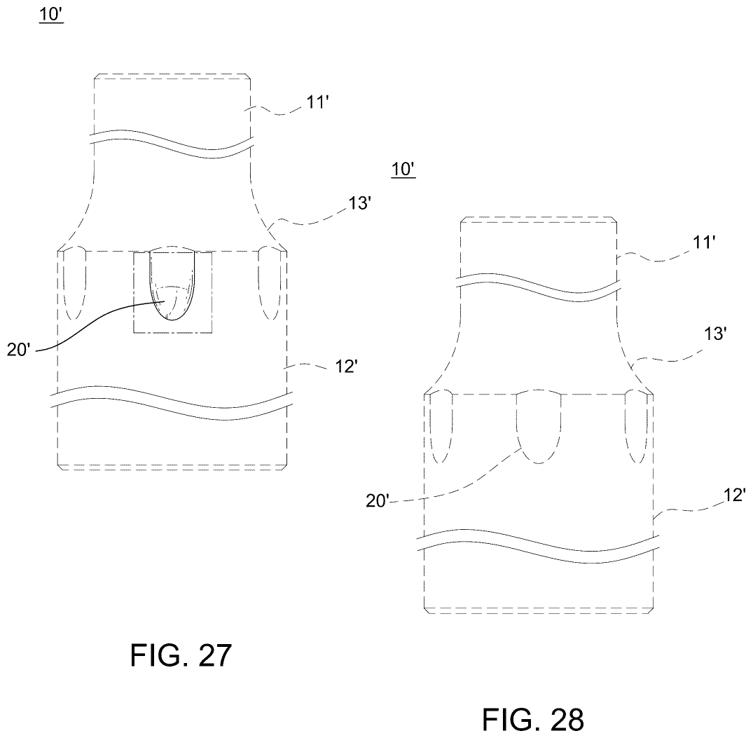

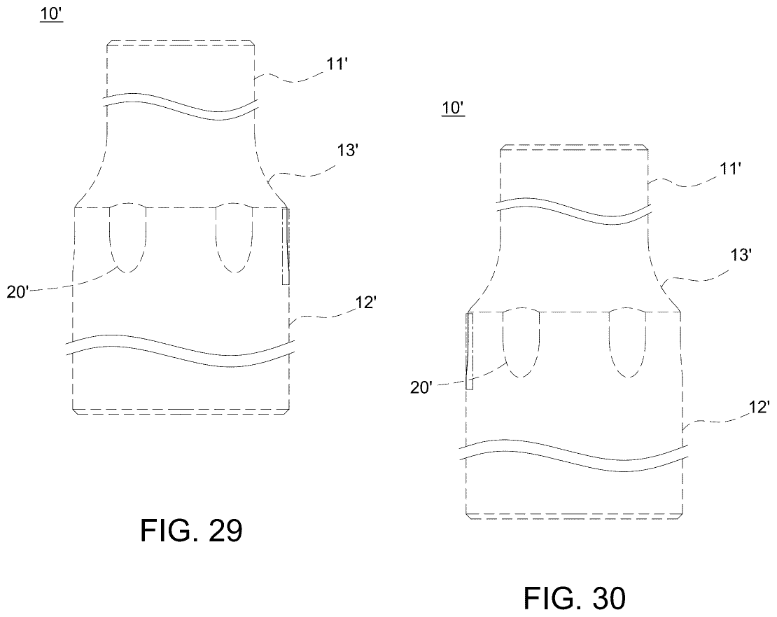

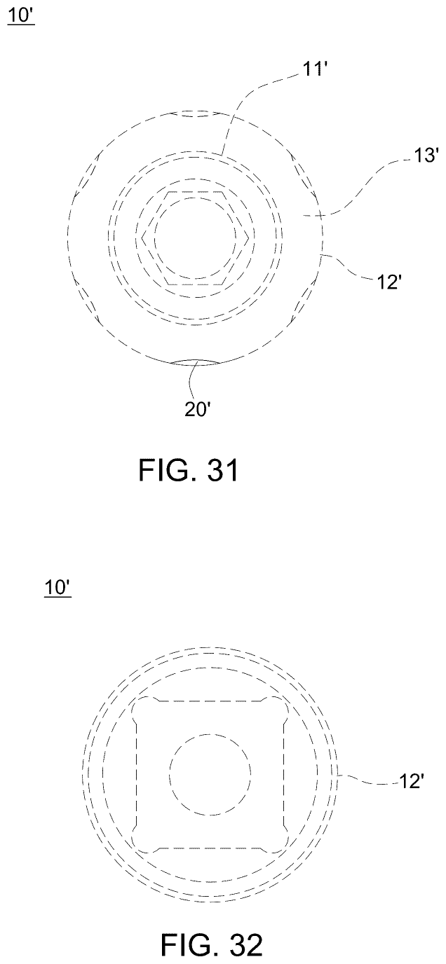

Referring to FIGS. 18 to 25, the third embodiment is described as follows. Refer to FIG. 18: the difference from the second embodiment lies in the variation of the groove portion 20′ to an approximately capsule-shaped configuration, while the body 10′ remains unchanged. The body 10′ in perspective view (refer to FIG. 18), in front view (refer to FIG. 19, with the rear view being identical to the front view, thus omitted), FIG. 19 uses break lines to indicate that the small-diameter section 11′ and large-diameter section 12′ have consistent shape, structure, or regular variation along their length. In left side view (refer to FIG. 20, with the right side view being identical to the left side view, thus omitted), in top view (refer to FIG. 21), in bottom view (refer to FIG. 22). Additionally, different variant configurations of the body 10′ incorporate the approximately capsule-shaped groove portion 20′ (refer to FIGS. 23, 24, 25). The third embodiment may also refer to FIGS. 26 to 32.

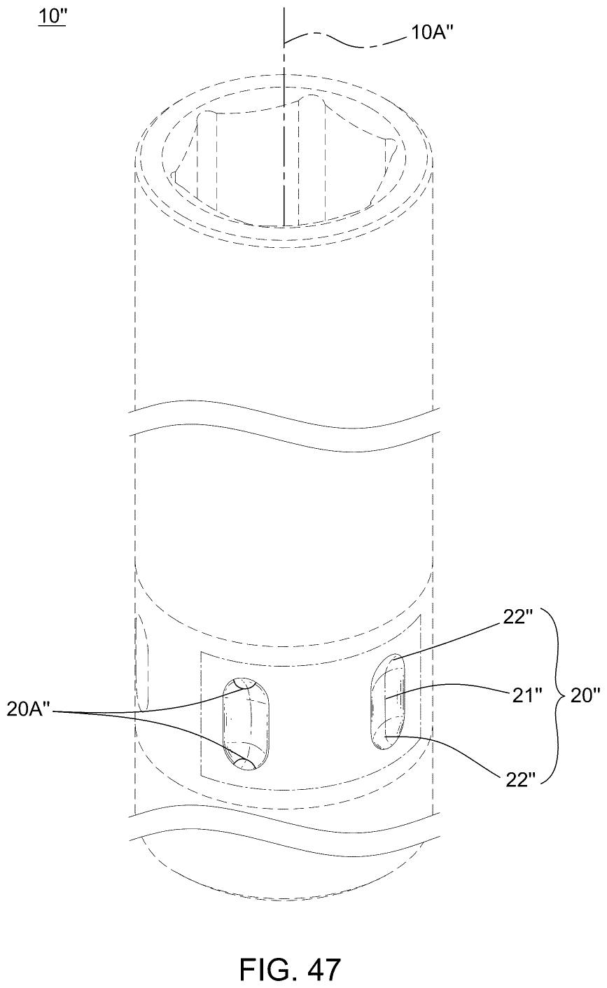

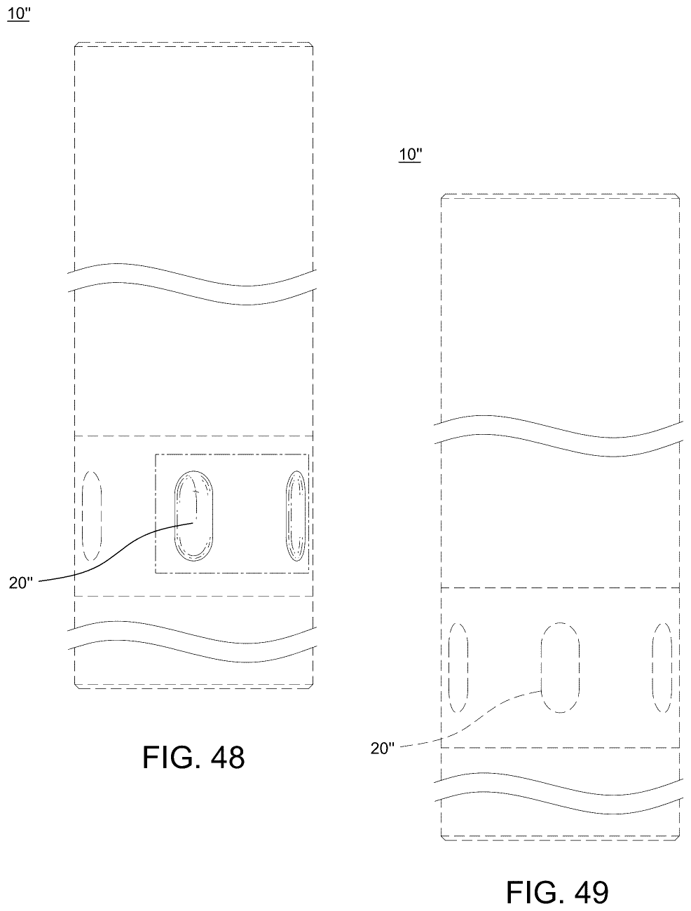

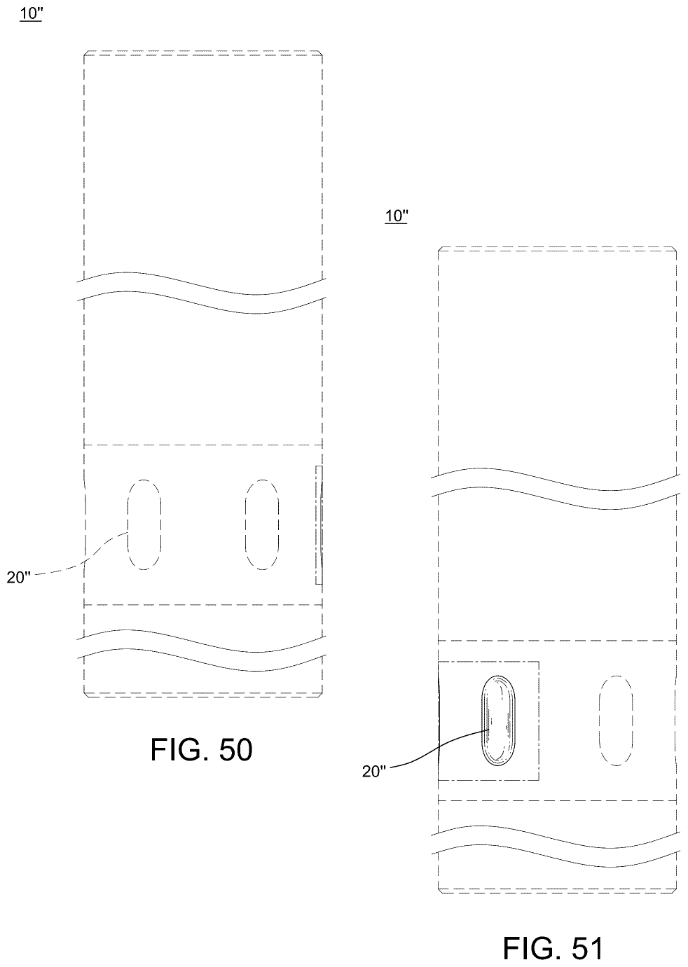

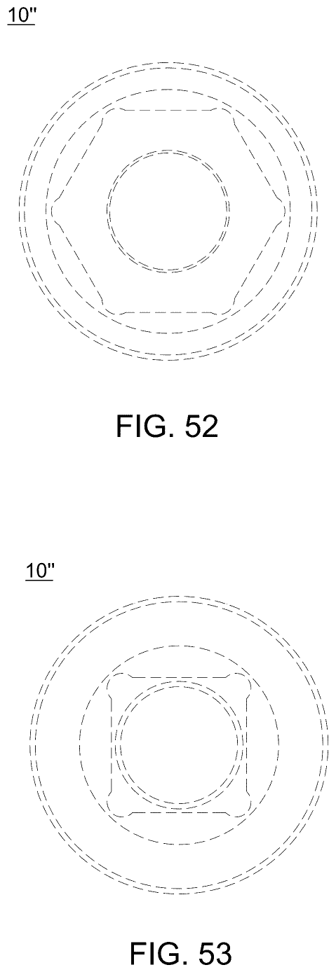

Referring to FIGS. 47 to 53, the fourth embodiment is described as follows. Refer to FIG. 47: the differences from the first, second, and third embodiments lie in that the body 10″ has a uniform outer diameter extending along the axis, without division into small-diameter and large-diameter sections. This equal-diameter design provides better strength distribution. Each groove portion 20″ of the body 10″ is tapered toward both ends along the axis 10A″ and has two included angles 20A″. The straight section 21″ remains as one, while the tapered sections 22″ corresponding to the included angles 20A″ increase to two. This results in the groove portions 20″ arranged between the two axial ends of the body 10″ forming a bi-directional tapered structure, enhancing the anti-slip effect. The single-directional tapered structure disclosed by the groove portions 20, 20′ and the bi-directional tapered structure disclosed by the groove portion 20″ can be used individually or in combination.

Considering the distribution of structural strength at both ends of the body 10, 10′, 10″ of the wrench socket of the present invention, the groove portions 20, 20′ of the first, second, and third embodiments are not provided on the side surface 12A at both ends of the body 10, 10′. Similarly, the groove portion 20″ of the fourth embodiment of the present invention is not provided on the side surface 12A at both ends of the body 10″. Therefore, the groove portions 20, 20′, 20″ are provided on the side surface 12A between the two ends of the body 10, 10′, 10″, but not on the side surface at both ends. This ensures that the ends of the body 10, 10′, 10″ maintain structural integrity and strength performance when subjected to torsional force.

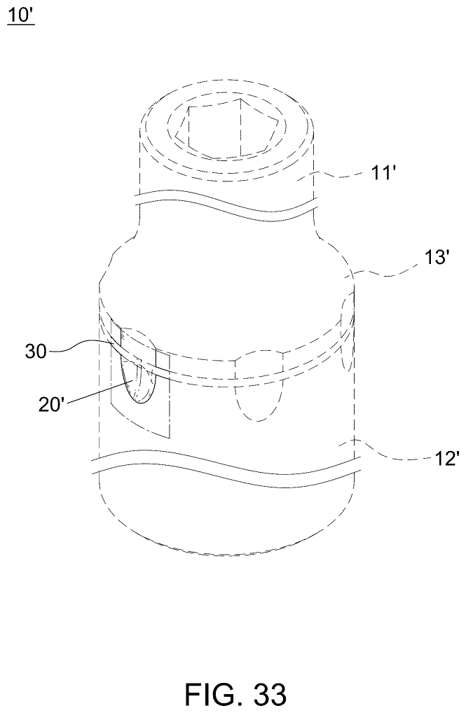

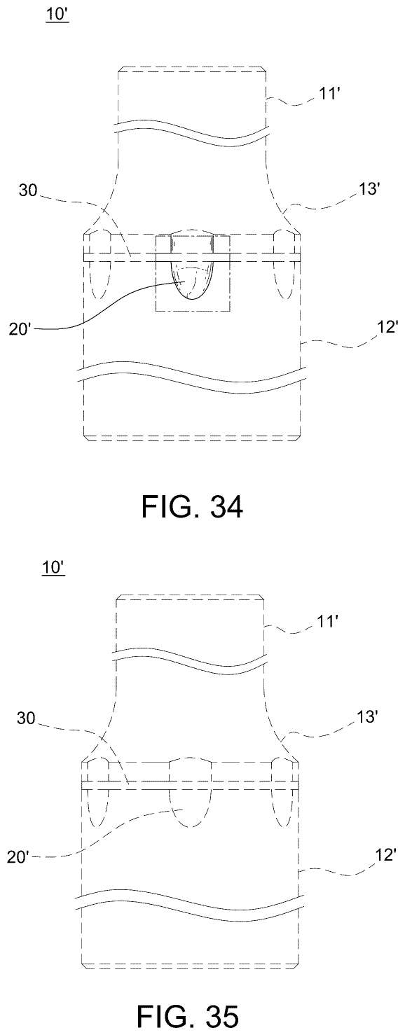

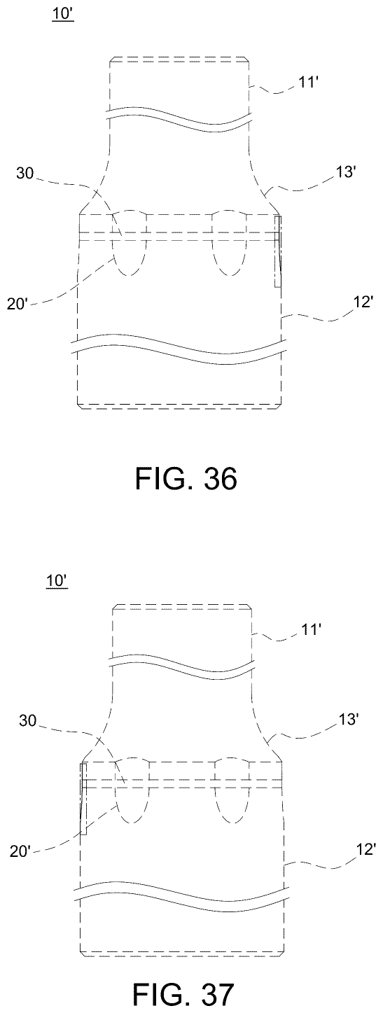

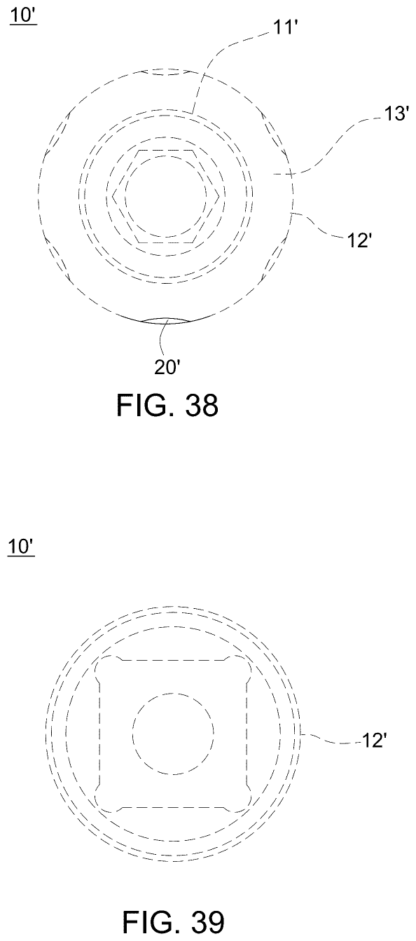

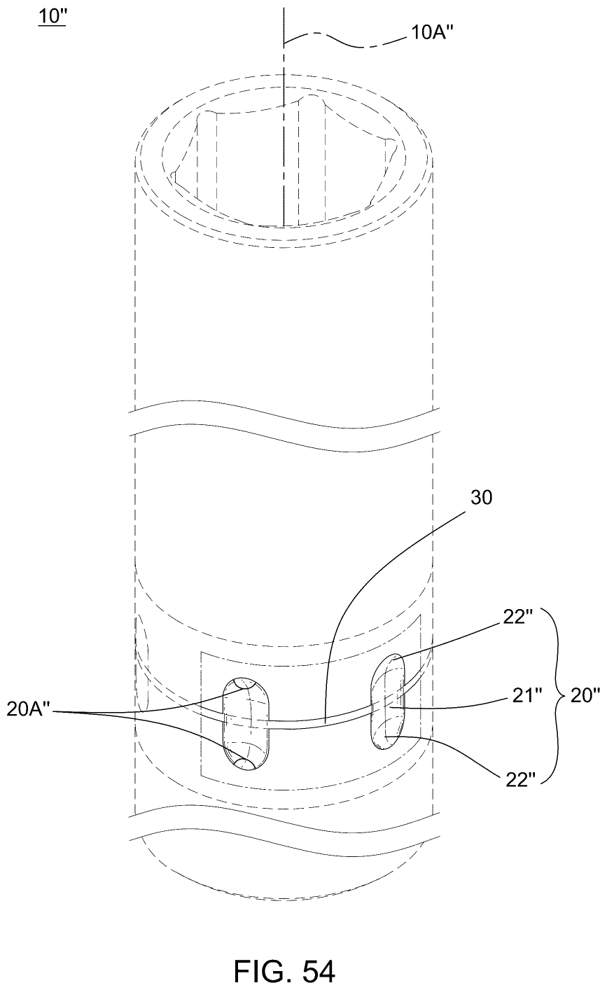

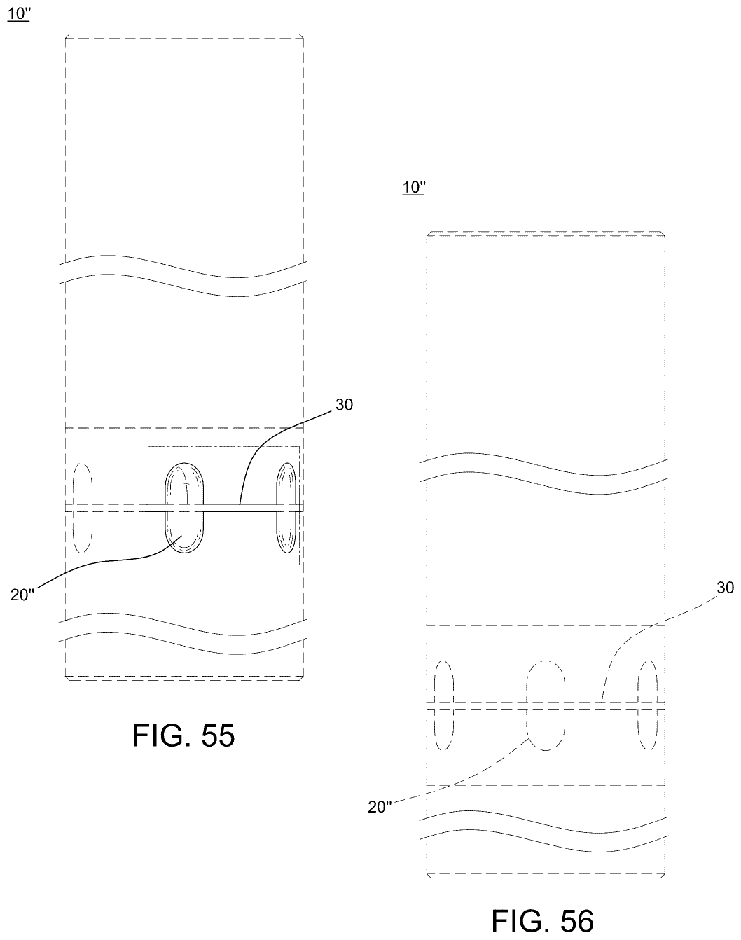

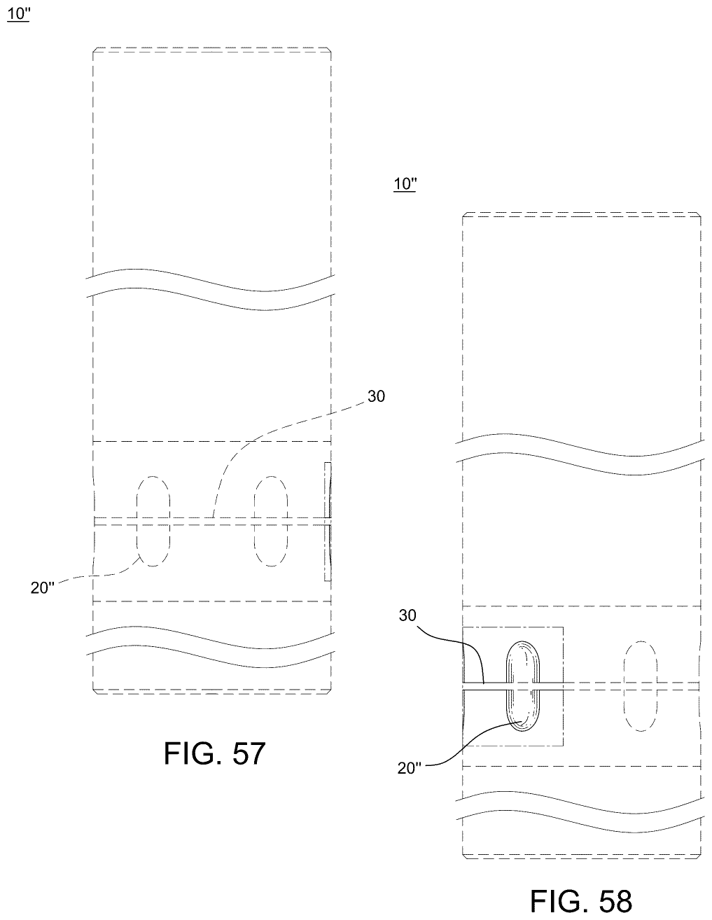

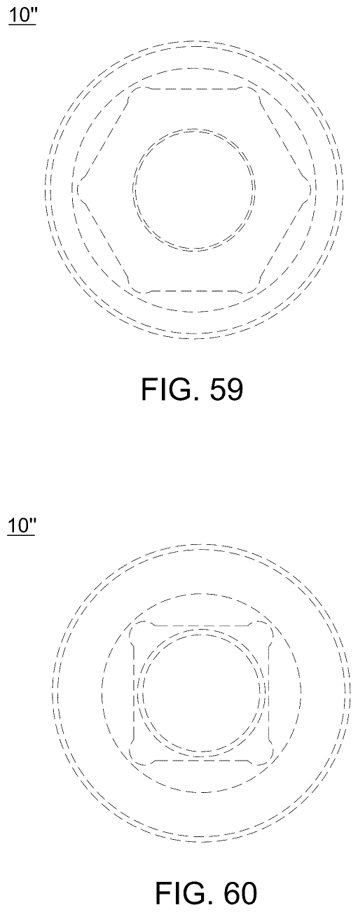

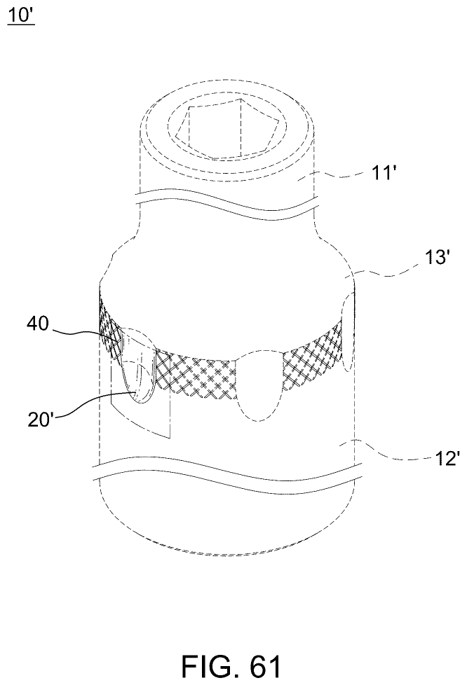

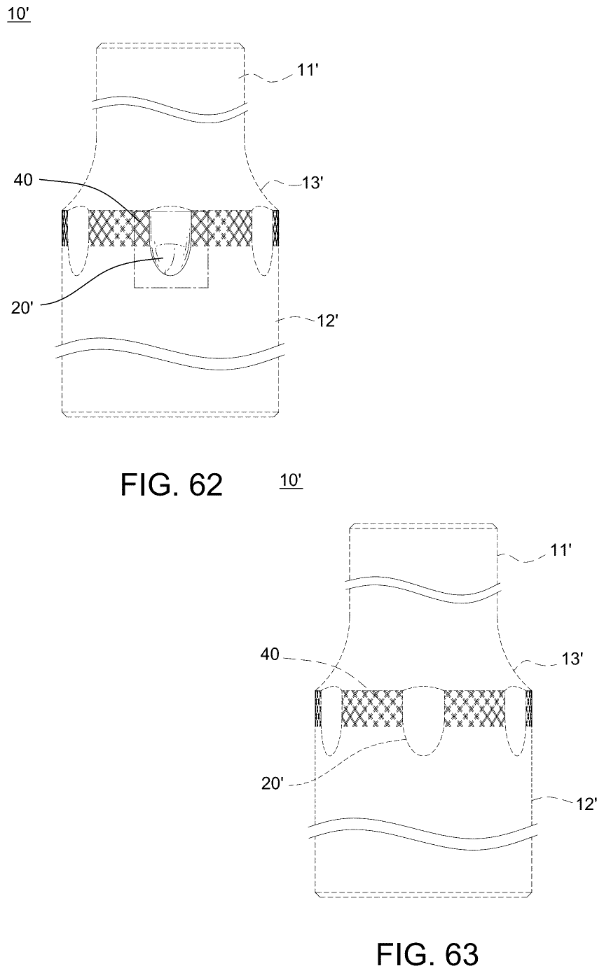

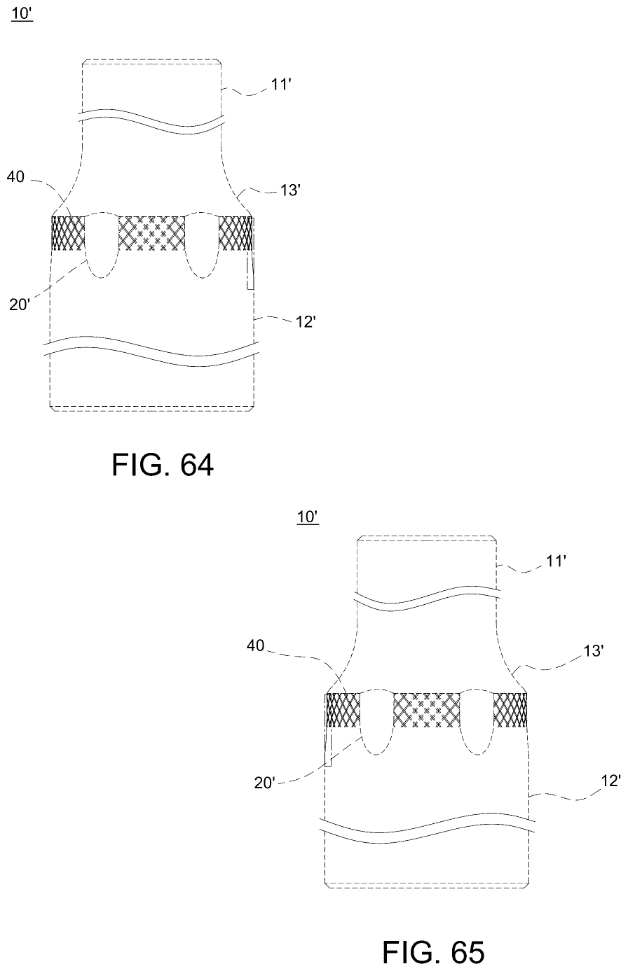

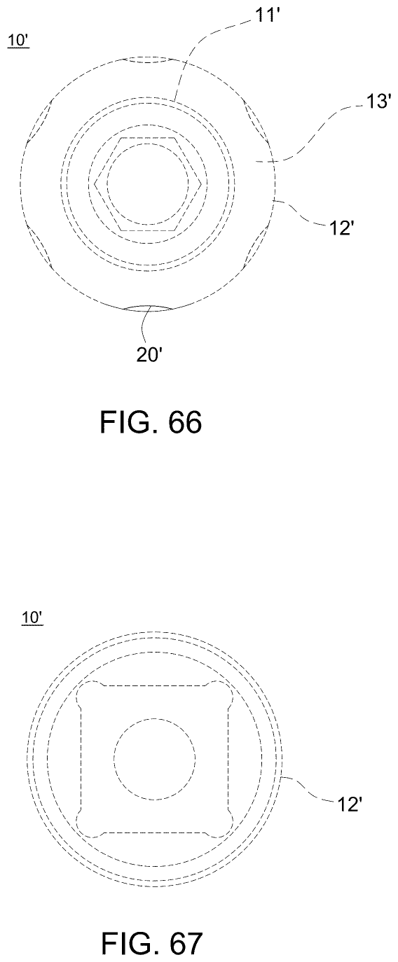

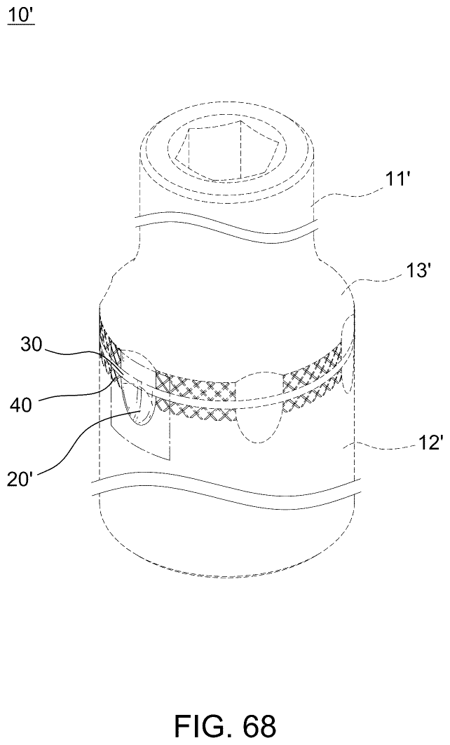

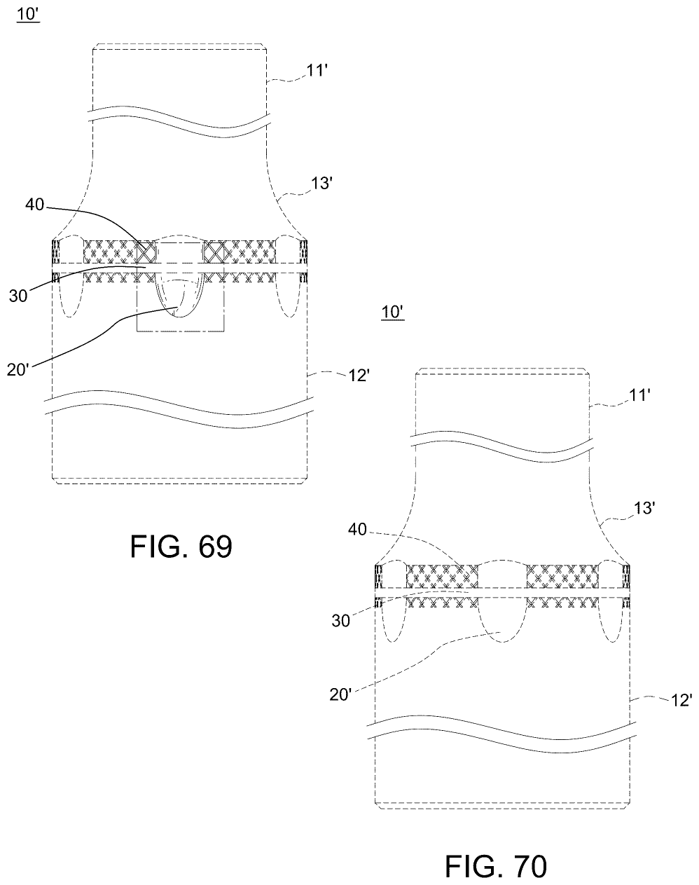

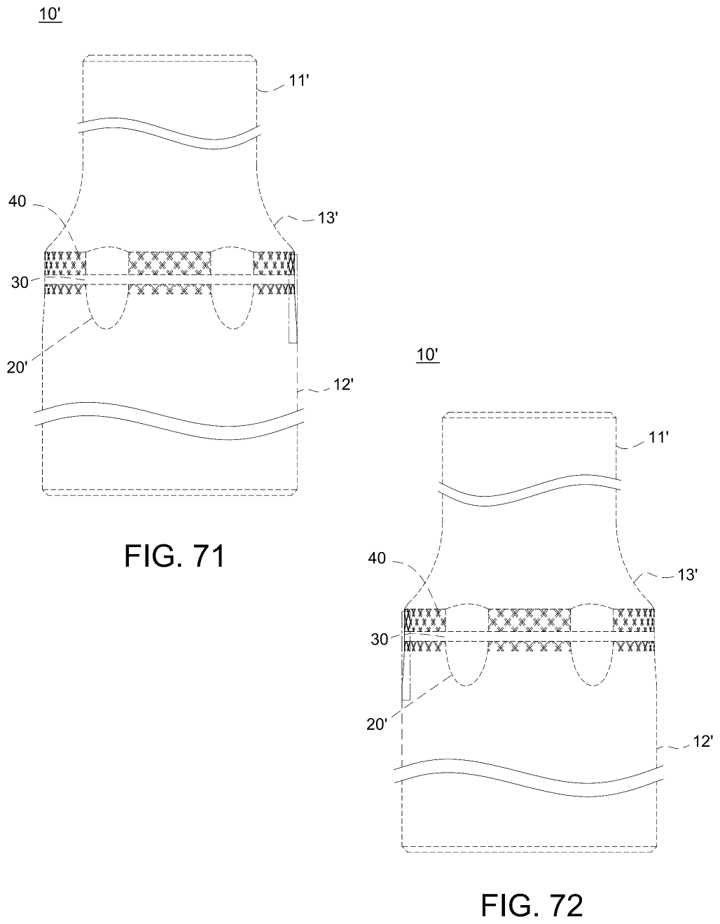

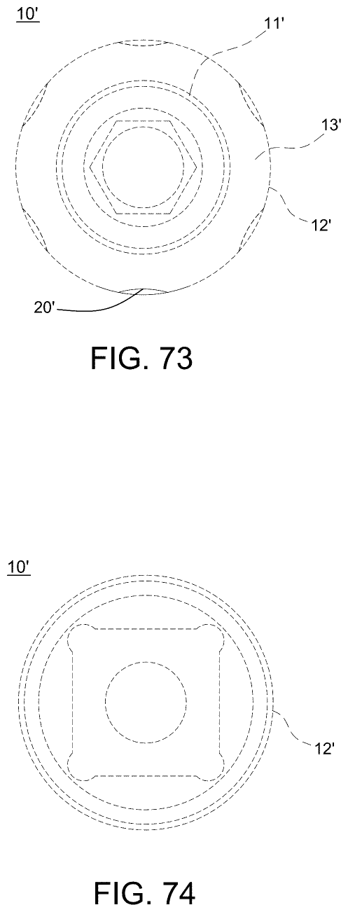

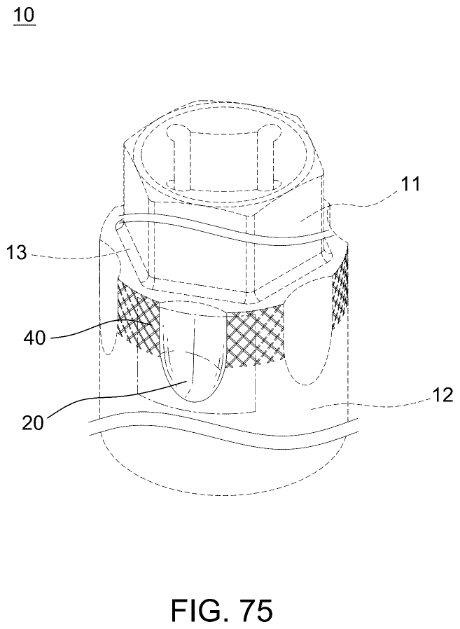

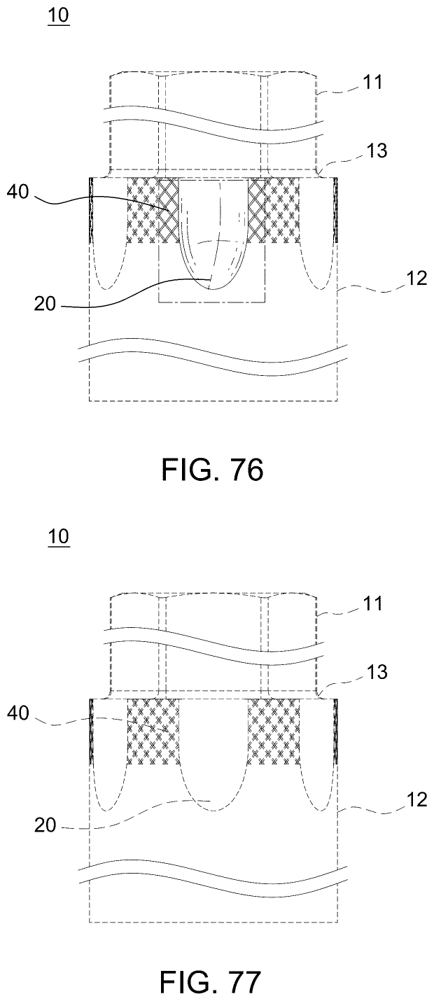

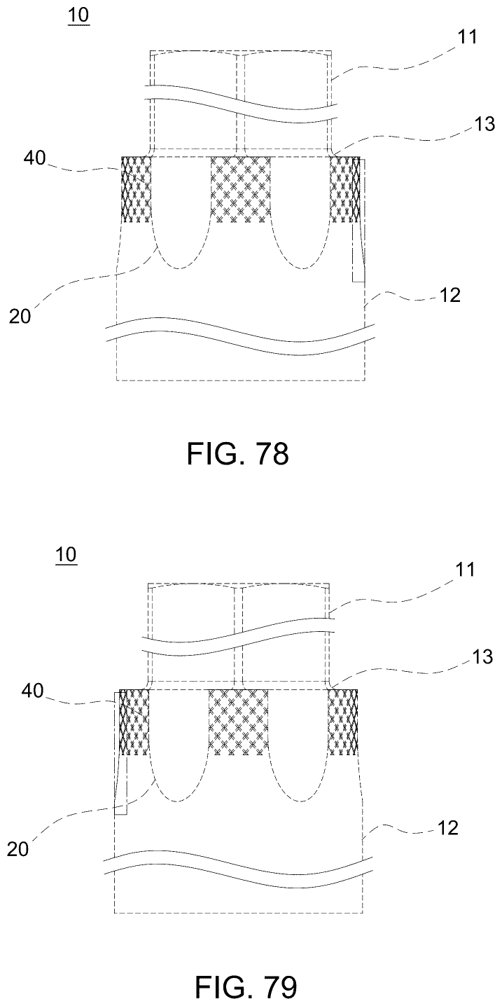

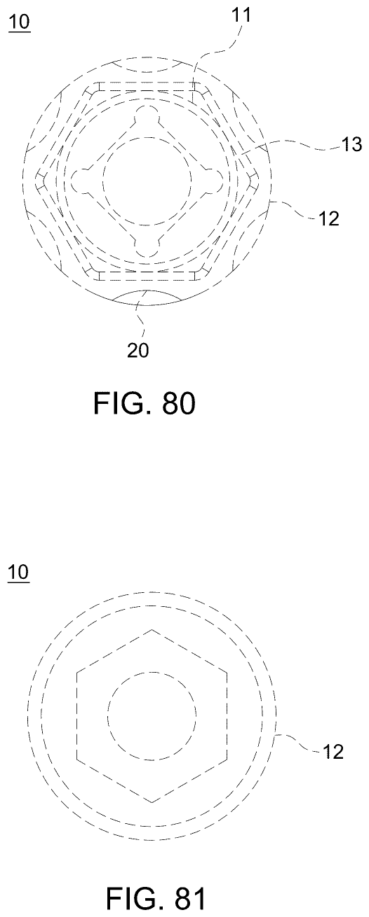

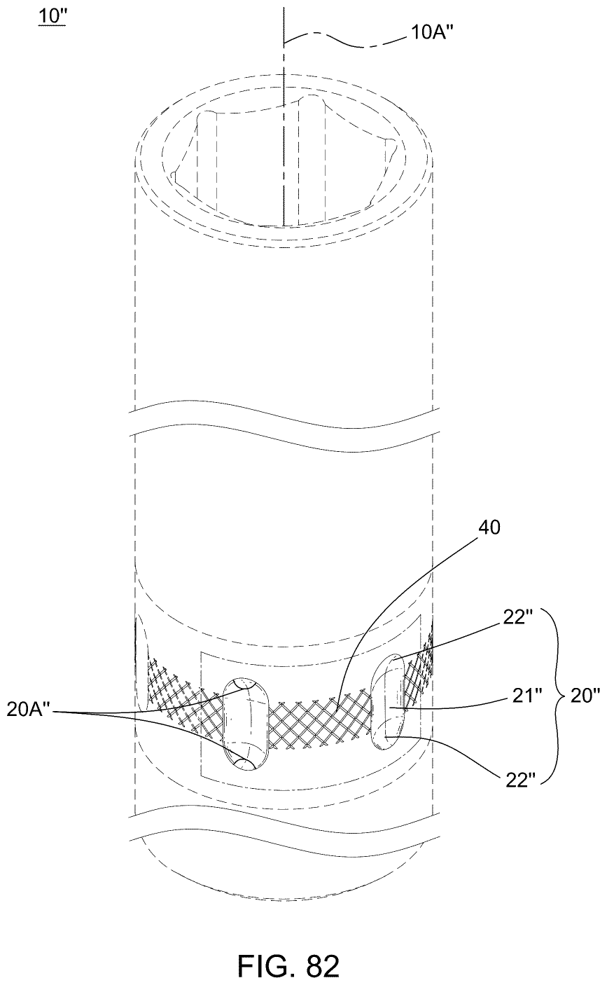

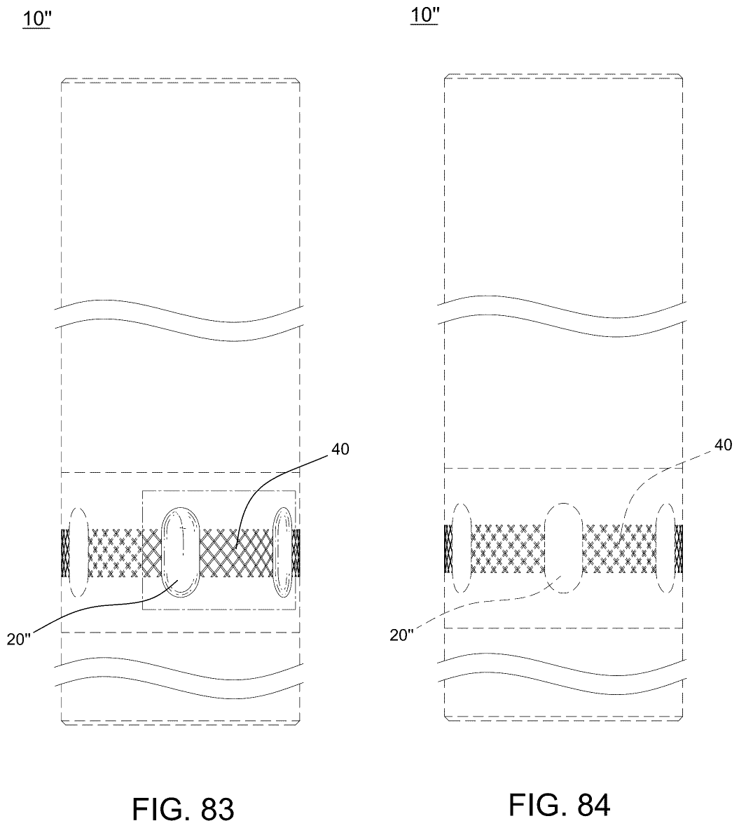

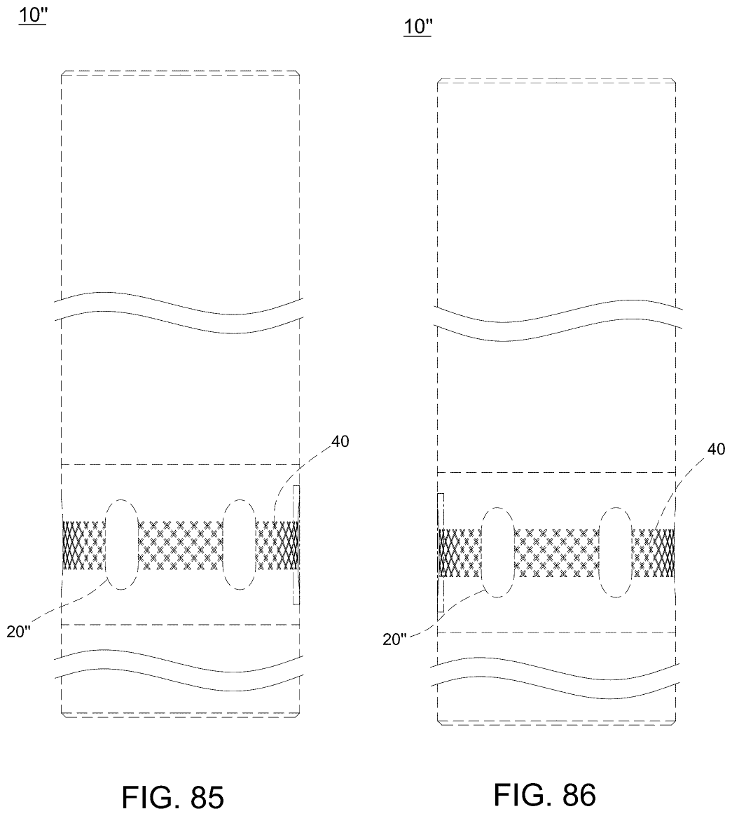

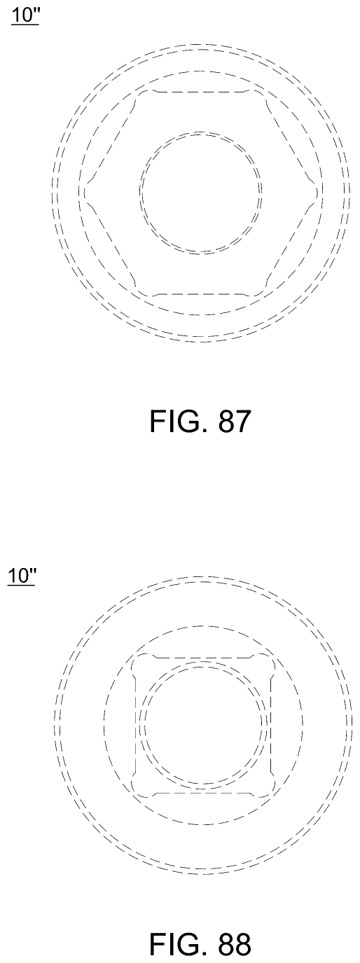

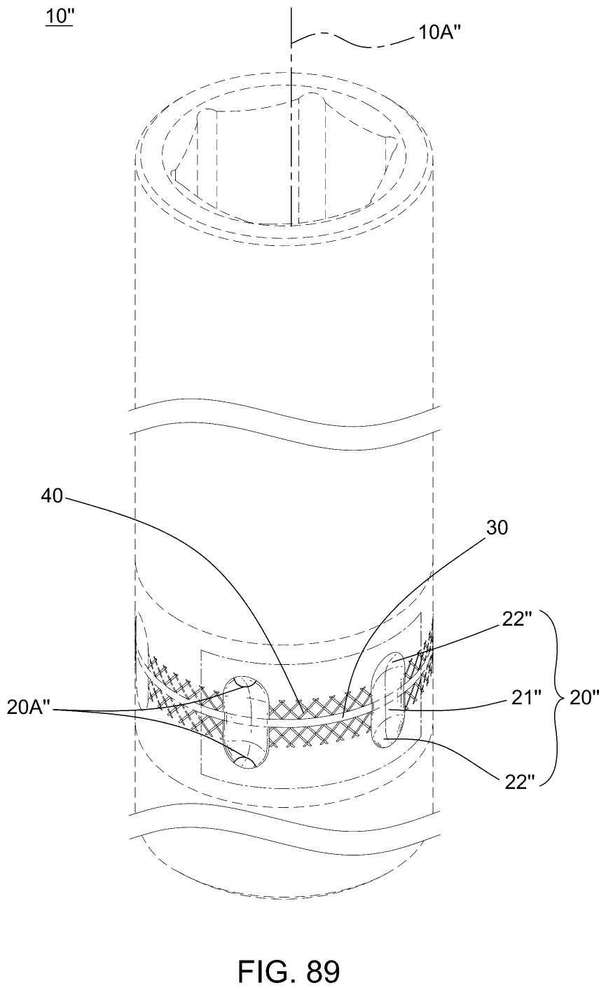

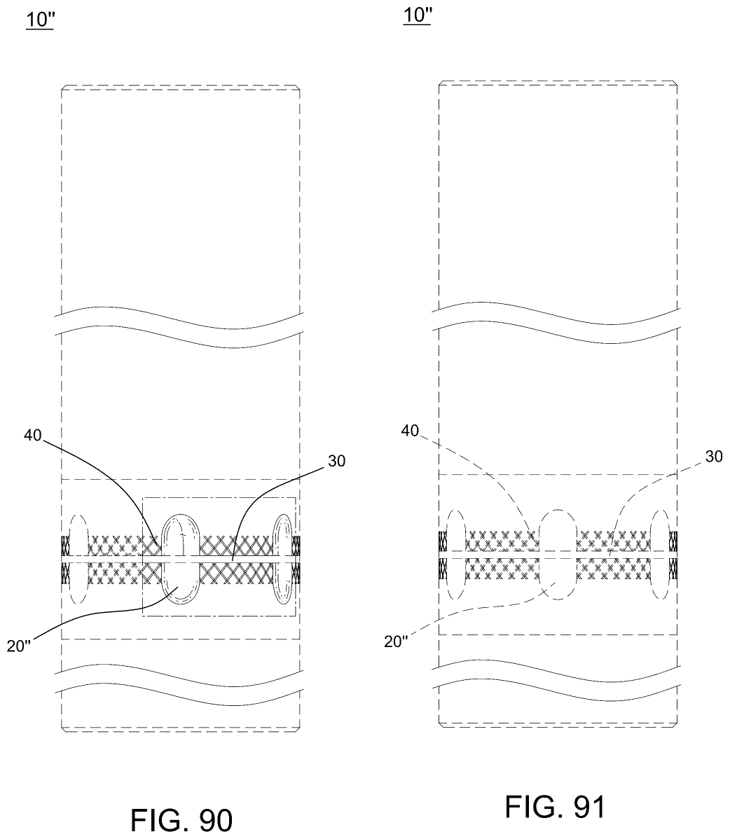

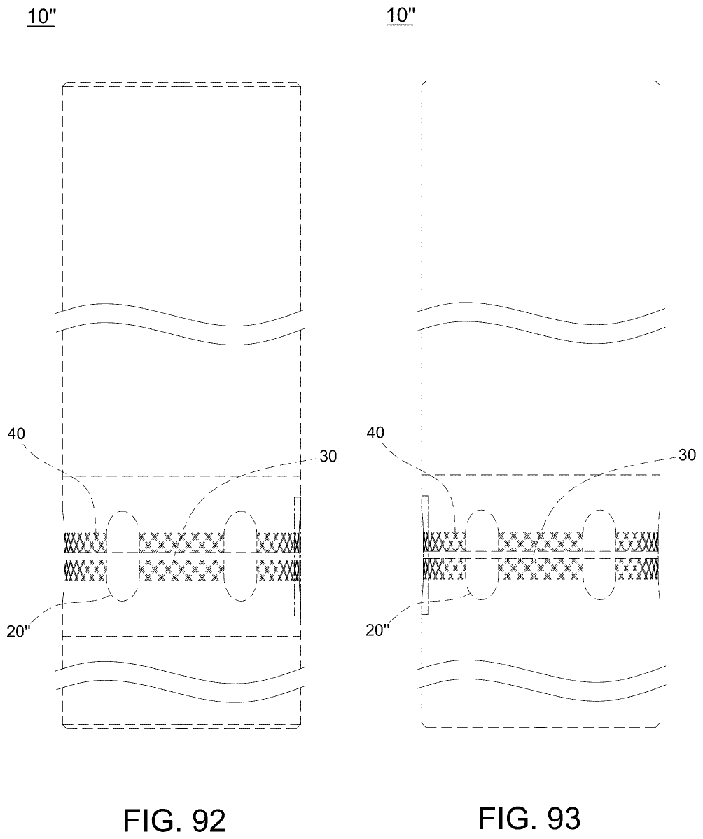

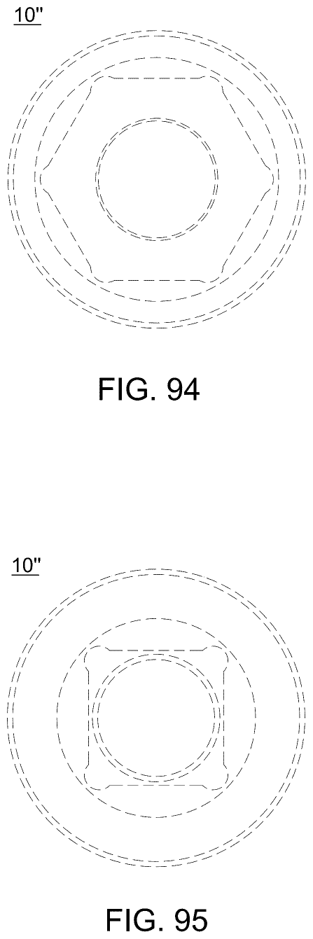

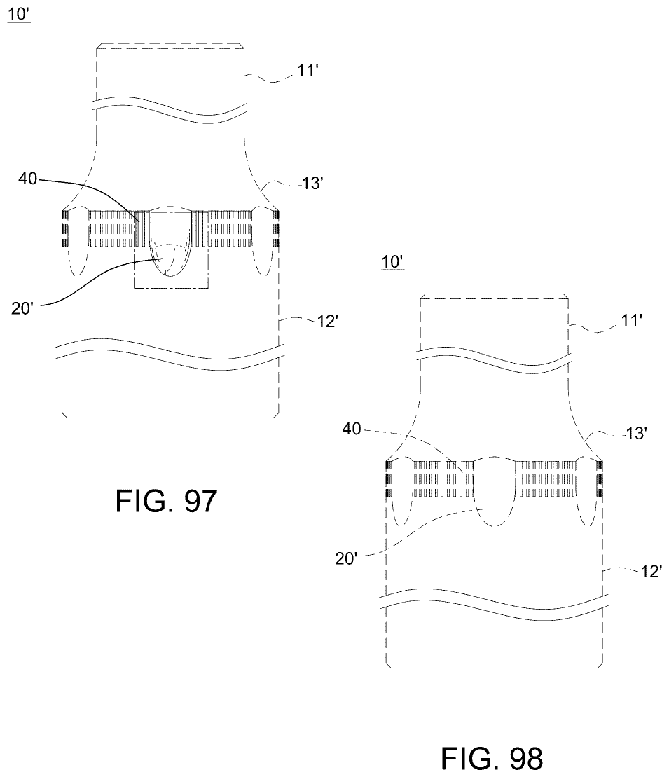

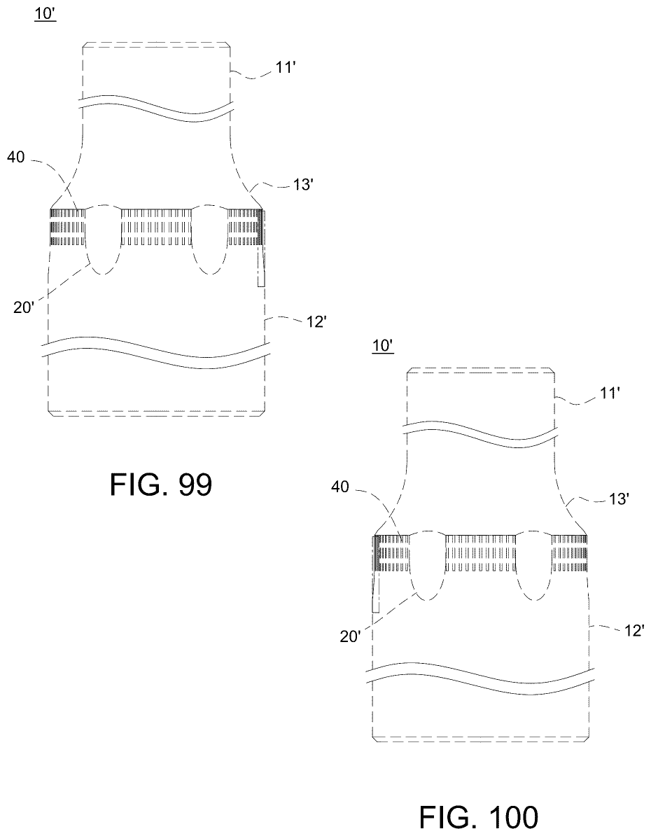

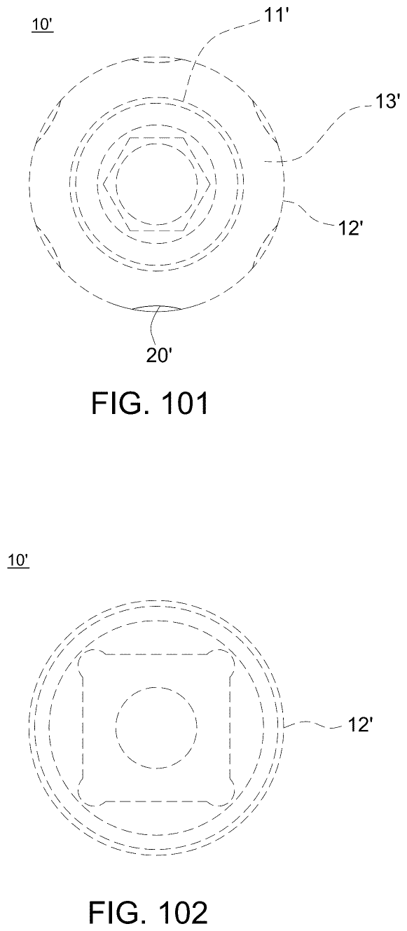

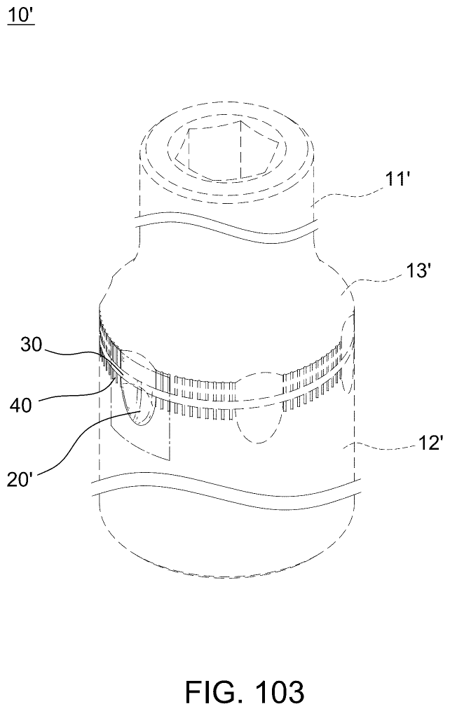

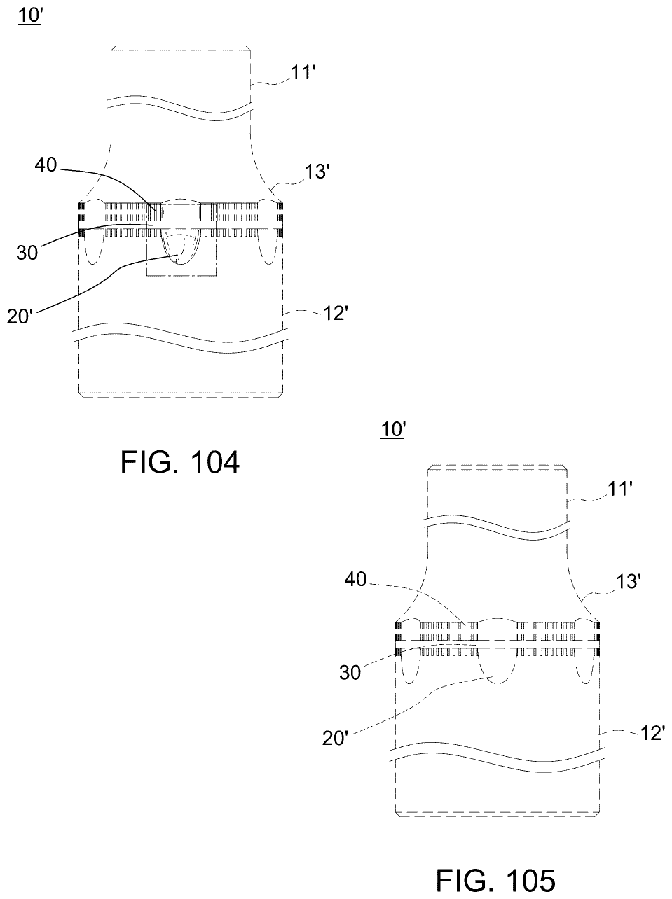

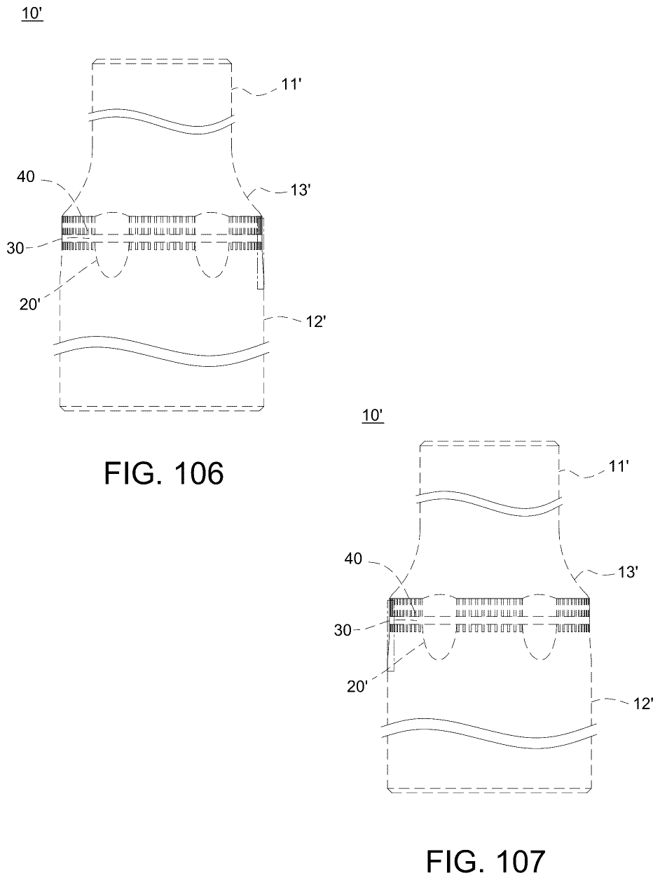

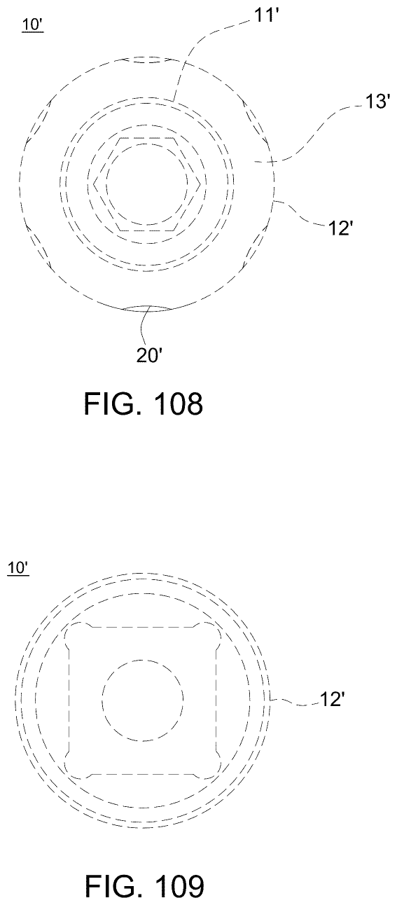

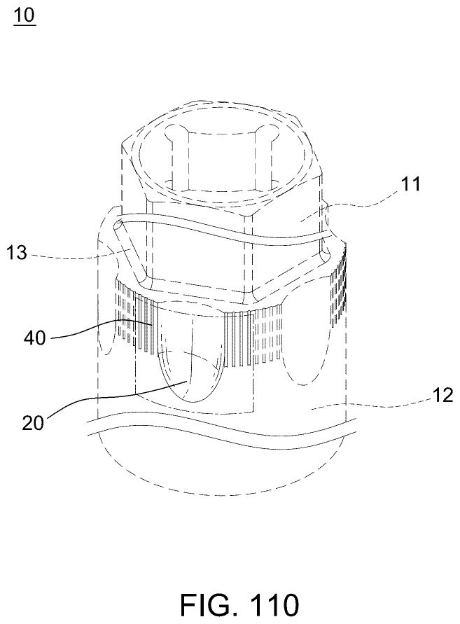

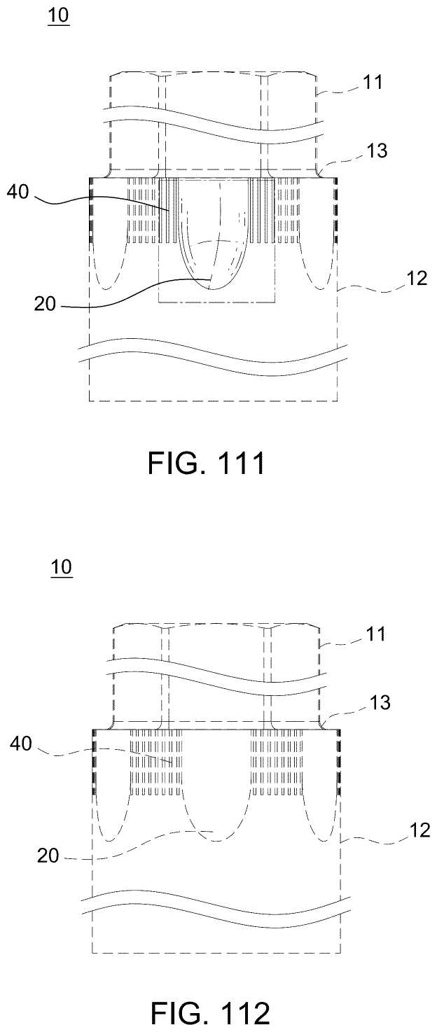

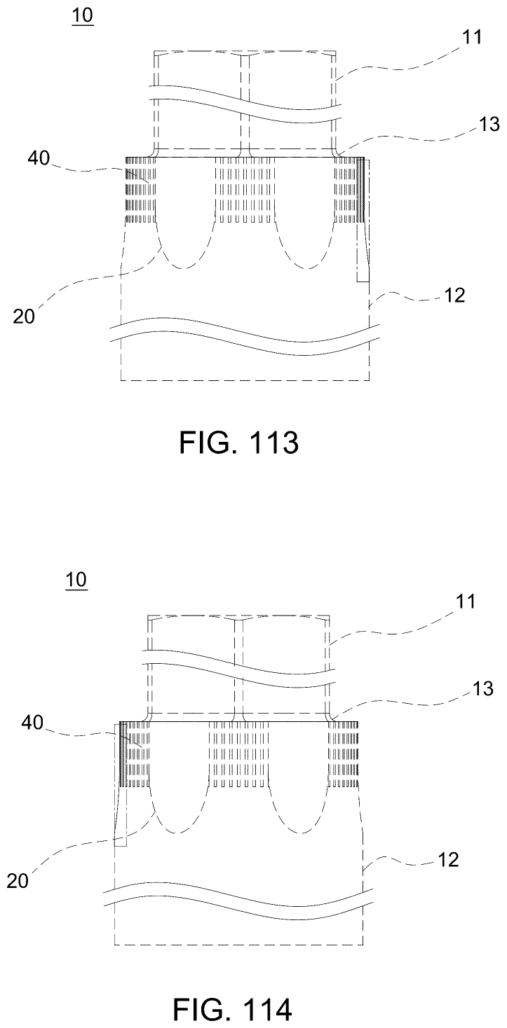

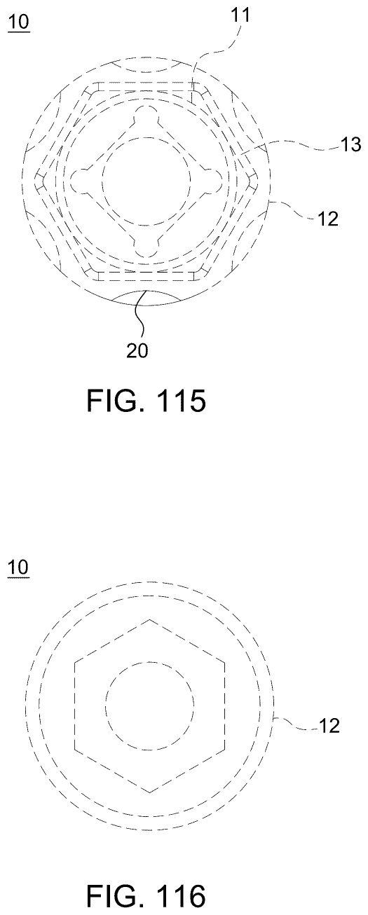

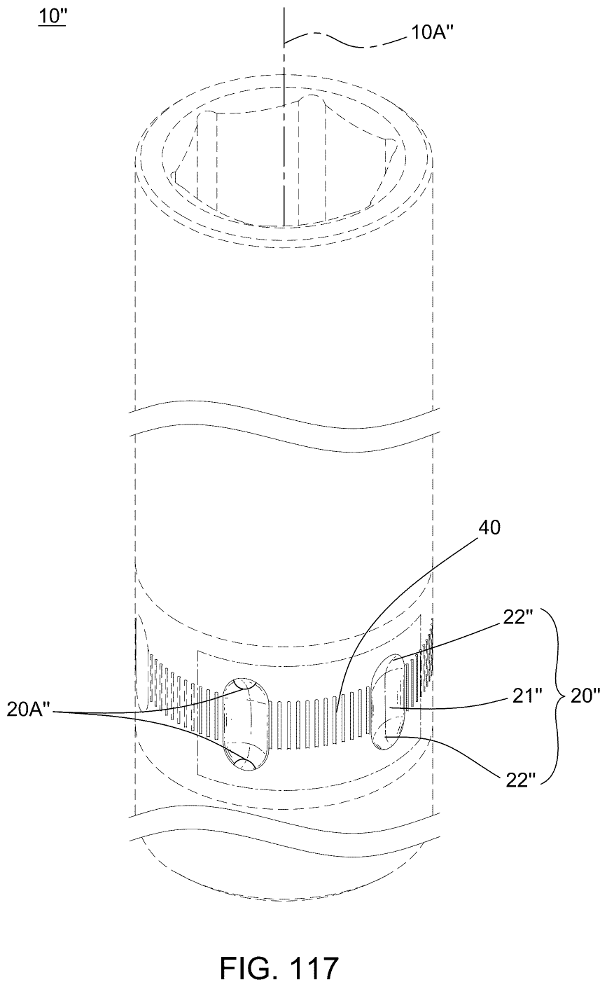

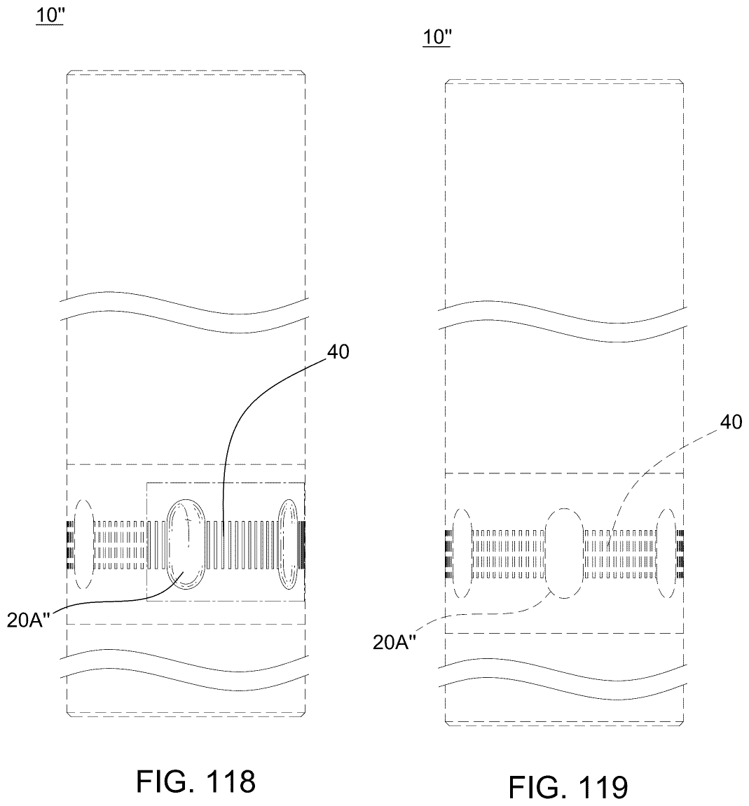

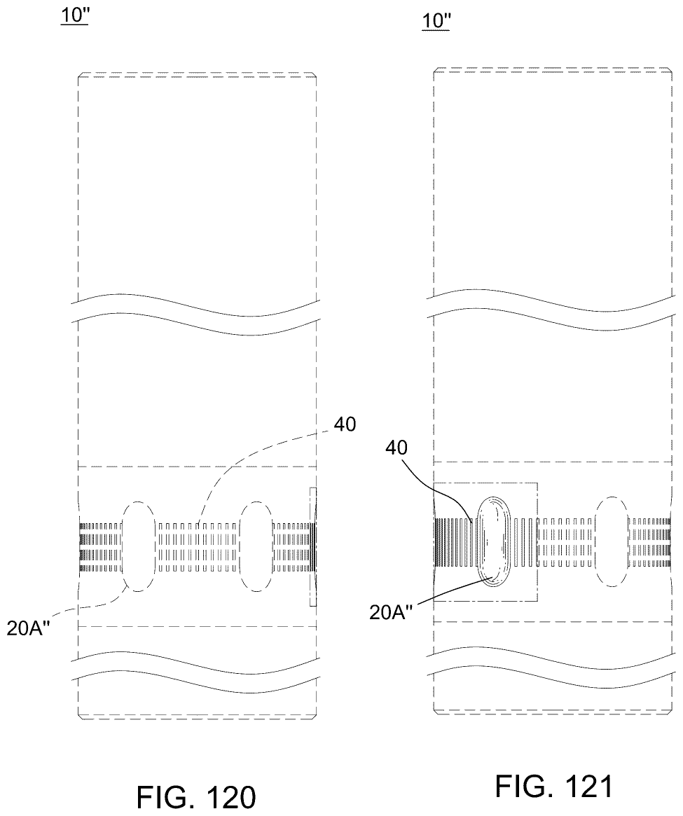

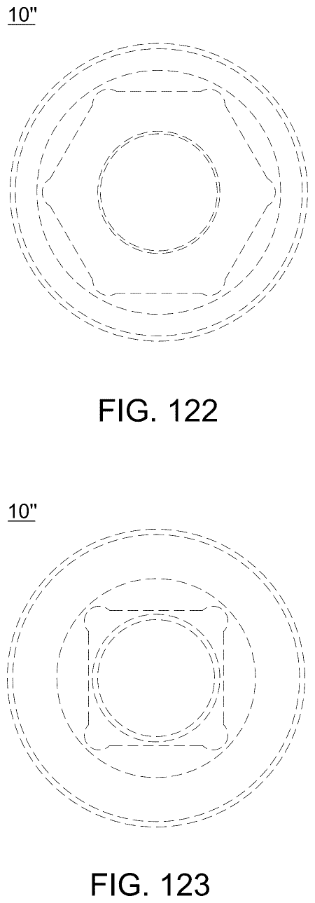

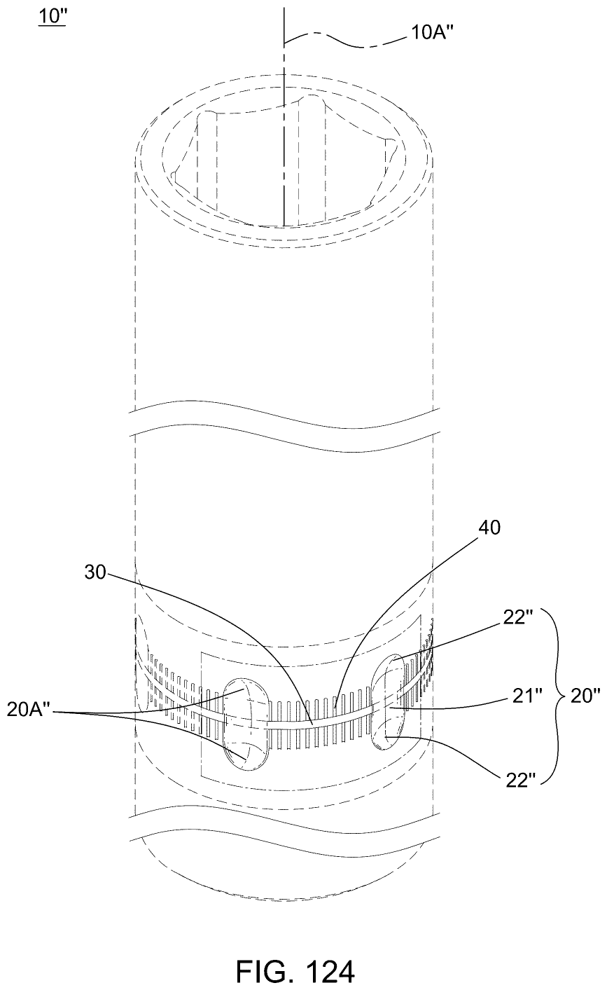

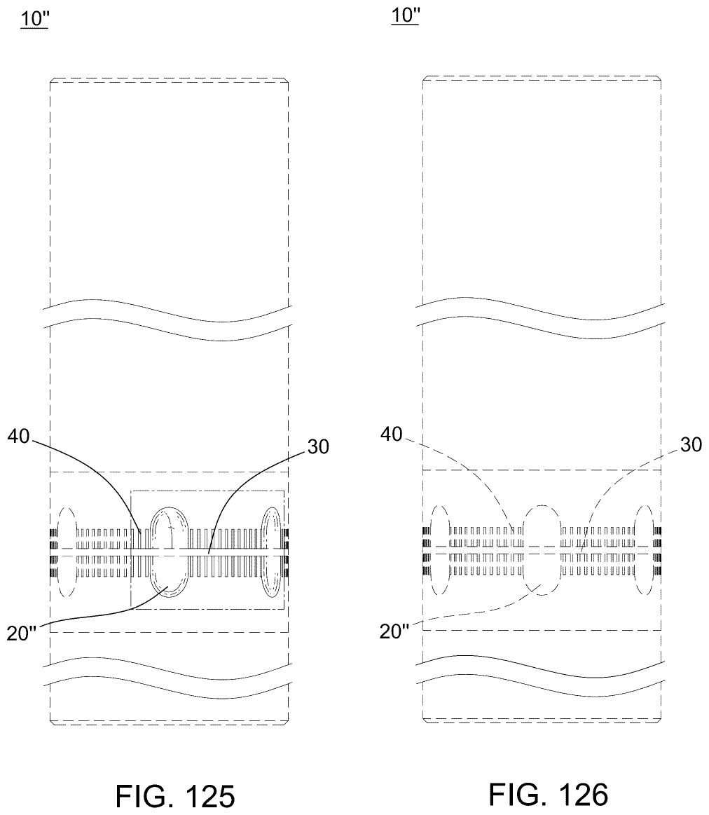

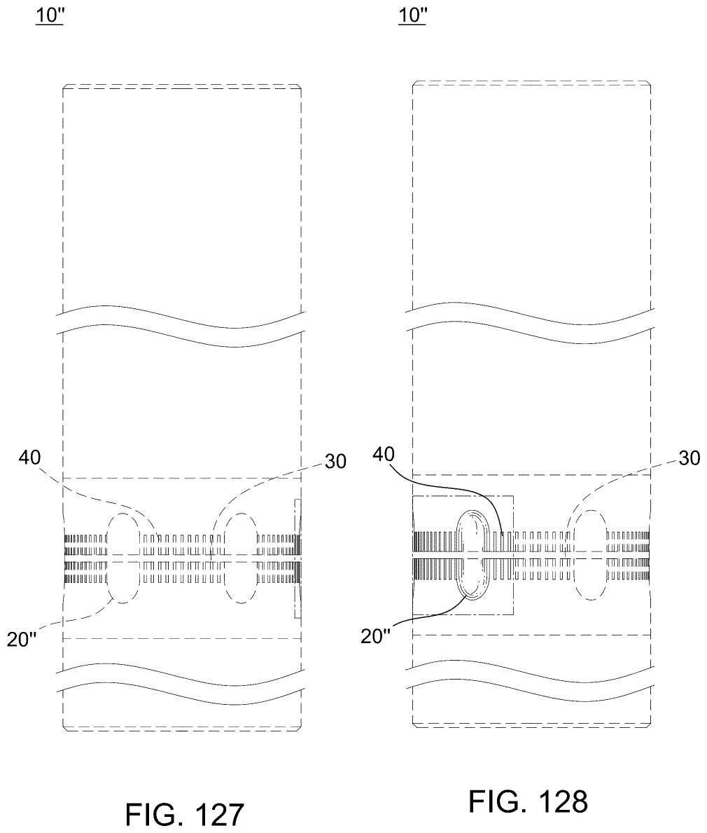

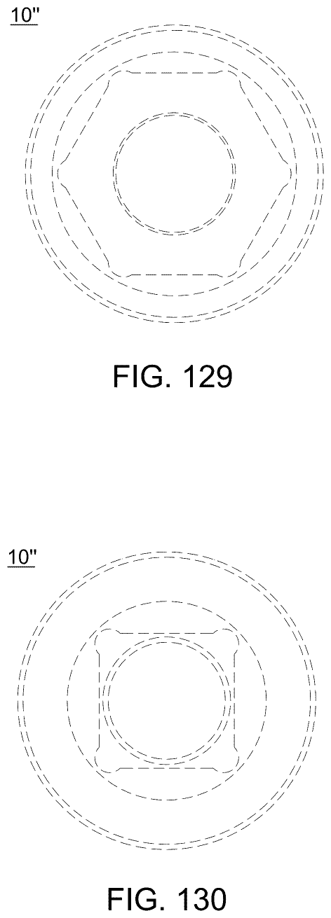

The present invention further provides two structural designs for anti-slip and anti-rolling functions, namely an annular groove portion 30 (refer to FIGS. 33 to 39, FIGS. 54 to 60, FIGS. 68 to 74, FIGS. 89 to 95, FIGS. 103 to 109, and FIGS. 124 to 130) and an embossed portion 40 (refer to FIGS. 61 to 67, FIGS. 68 to 74, FIGS. 75 to 81, FIGS. 82 to 88, FIGS. 89 to 95, FIGS. 96 to 109, FIGS. 110 to 116, and FIGS. 117 to 130). Both can be positioned between any two groove portions 20, 20′, 20″, and can be used individually (refer to FIGS. 33 to 39, FIGS. 54 to 60, FIGS. 61 to 67, FIGS. 75 to 81, FIGS. 82 to 88, FIGS. 96 to 102, FIGS. 110 to 116, and FIGS. 117 to 123) or in combination (refer to FIGS. 68 to 74, FIGS. 89 to 95, FIGS. 103 to 109, and FIGS. 124 to 130) to achieve the optimal anti-slip and anti-rolling effects. The specific implementations of these two structures will be described in detail below.

The present invention provides at least one annular groove portion 30 positioned between any two groove portions 20, 20′, 20″ on the side surface 12A. The annular groove portion 30 may be adjacent to, connected to, overlapping with, or have other equivalent positional relationships with the groove portions 20, 20′, 20″. The annular groove portion 30 surrounds the side surface 12A around the circumference of the body 10, forming an annular structure perpendicular to the axis 10A. The annular groove portion 30 intersects with the plurality of groove portions 20, 20′, 20″ on the side surface 12A, forming an interlaced structure. When the annular groove portion 30 intersects with the groove portions 20, 20′, 20″, the annular groove portion 30 may continuously pass through the groove portions 20, 20′, 20″, or may be interrupted at the groove portions 20, 20′, 20″, depending on the requirements of different embodiments. The number of annular groove portions 30 may be at least one, and when multiple annular groove portions 30 are provided, these annular groove portions 30 may be distributed on the side surface 12A at equal or unequal distances. The width and depth of the annular groove portion 30 may be the same as or different from those of the groove portions 20, 20′, 20″, and its cross-sectional shape may be rectangular, arc-shaped, V-shaped, U-shaped, or other geometric shapes.

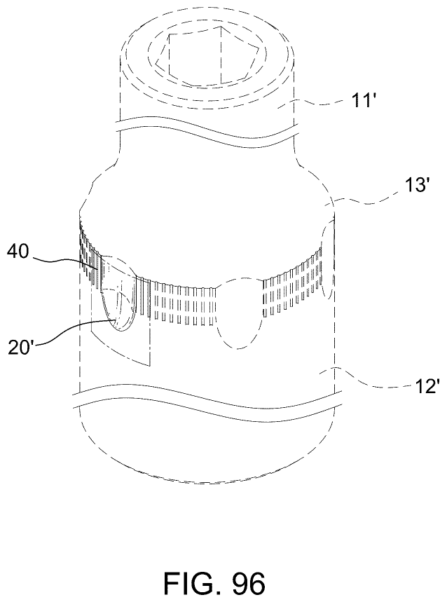

The present invention provides at least one embossed portion 40 positioned between any two groove portions 20, 20′, 20″ on the side surface 12A. The embossed portion 40 may be adjacent to, connected to, overlapping with, or have other equivalent positional relationships with the groove portions 20, 20′, 20″. The embossed portion 40 is formed on the surface of the side surface 12A, creating a geometric texture area composed of concave and convex structures, which significantly increases the friction for the user's hand contact. The embossed portion 40 may present cross-striped circular arrangements (refer to FIGS. 61 to 67, FIGS. 68 to 74, FIGS. 75 to 81, FIGS. 82 to 88, and FIGS. 89 to 95), straight-striped circular arrangements (refer to FIGS. 96 to 102, FIGS. 103 to 109, FIGS. 110 to 116, FIGS. 117 to 123, and FIGS. 124 to 130), or a matrix arrangement of multiple concave and convex geometric textures. The number of embossed portions 40 may be at least one, and when multiple embossed portions 40 are provided, these embossed portions 40 may be distributed uniformly or non-uniformly on the side surface 12A. The depth of the embossed portion 40 may be the same as or different from that of the groove portions 20, 20′, 20″, and its height, spacing, and density may vary according to the requirements of different embodiments.

In the present invention, both the annular groove portion 30 and the embossed portion 40 can be positioned between the groove portions 20, 20′, 20″, and can be provided individually or in combination on the side surface 12A according to different usage requirements and manufacturing considerations. When the annular groove portion 30 or the embossed portion 40 is used individually, each can provide anti-slip and anti-rolling effects; when the annular groove portion 30 and the embossed portion 40 are used in combination, they can form more comprehensive anti-slip and anti-rolling features. In embodiments where they are used in combination, the annular groove portion 30 and the embossed portion 40 can be arranged adjacent to each other, for example, the annular groove portion 30 can be positioned between two adjacent embossed portions 40, or the embossed portion 40 can be positioned between two adjacent annular groove portions 30. Alternatively, the annular groove portion 30 and the embossed portion 40 can be positioned in different areas of the side surface 12A. The combined design of the annular groove portion 30 and the embossed portion 40 is suitable for high-precision, high-torque, or harsh environment operation requirements, significantly enhancing the convenience and safety of tool use.

In summary, the present invention provides a wrench socket which, by means of the straight section 21 and the tapered section 22 of the groove portion 20, prevents the body 10 (refer to FIG. 5) from rolling when placed at a workplace. When the palm with dirt (sweat or oil) grips the body 10 (refer to FIG. 6), it prevents slipping. Thereby, operational inconvenience is avoided and operation time is shortened.

The wrench socket of the present invention is characterized by having groove portions 20, 20′, 20″, wherein the groove portions 20, 20′, 20″ are tapered along the axis 10A, and form an included angle 20A within the groove portions 20, 20′, 20″, thereby providing both anti-rolling and anti-slip functions while not affecting the structural strength, offering the following technical advantages:

Efficient Force Transmission: The tapered design concentrates force along the axial direction, reducing energy loss, improving transmission efficiency, and ensuring operational stability when subjected to torsional force.

Adaptive Anti-slip: When the applied torsional force increases, fingers are guided to narrower or shallower areas, causing the anti-slip effect to gradually enhance with the intensity of applied force, improving grip stability and effectively preventing slippage.

Anti-rolling Control: The tapered design forms stable support points, effectively reducing the risk of rolling on uneven surfaces or when placed down, thereby improving operational safety.

Material Optimization: Through the design that gradually narrows in width and decreases in depth, material usage is reduced while maintaining structural strength, not only effectively reducing weight but also lowering manufacturing costs.

All documents cited in this specification are hereby individually and specifically incorporated into this specification as reference documents. To the extent that any definition or usage of a term in a cited document is inconsistent with or contradicts the definition or usage of that term in this specification, the definition in this specification shall prevail, and the definition of that term in the cited document shall not apply.

The benefits and advantages which may be provided by the present invention have been described above with regard to specific embodiments. These benefits and advantages, and any elements or limitations that may cause them to occur or to become more pronounced, are not to be construed as critical, required, or essential features of any or all of the embodiments.

The foregoing description of the preferred embodiments of the present invention has been presented for the purposes of illustration and description. It is not intended to be exhaustive or to limit the invention to the precise forms disclosed. Many modifications and variations are possible in light of the above teachings. It is intended that the scope of the invention not be limited by this detailed description, but by the claims and the equivalents to the claims appended hereto.

What is claimed is:

1. A wrench socket comprising:
a body having an axis and a side surface, wherein a plurality of groove portions are arranged at intervals around the side surface, each of the plurality of groove portions is formed on the side surface between two ends of the body along the axis, and each of the plurality of groove portions is tapered along the axis and has an included angle.

2. The wrench socket as claimed in claim 1, wherein the body is provided with a small-diameter section and a large-diameter section connected to the small-diameter section along the axis, the side surface is provided on the large-diameter section of the body, the plurality of groove portions are arranged at intervals around the side surface of the large-diameter section, the body has a connecting section connecting the small-diameter section and the large-diameter section, the small-diameter section is provided with a force-receiving part from one end of the body along the axis, the large-diameter section is provided with a force-applying part from another end of the body along the axis, the force-receiving part of the small-diameter section combines with a driving member, the force-applying part of the large-diameter section combines with a driven member, wherein when force is applied to the driving member, the force-receiving part of the small-diameter section rotates under force, causing the force-applying part of the large-diameter section to apply force to the driven member, thereby causing the driven member to rotate under force.

3. The wrench socket as claimed in claim 1, wherein the side surface further defines a first end and a second end, each of the plurality of groove portions starts from the second end and terminates before the first end.

4. The wrench socket as claimed in claim 1, wherein the side surface further defines a first end and a second end, each of the plurality of groove portions starts from the first end and terminates before the second end.

5. The wrench socket as claimed in claim 1, wherein the side surface further defines a first end and a second end, wherein a dividing line is defined between the first end and the second end, and each of the plurality of groove portions starts from the second end and terminates at the dividing line or terminates before the dividing line.

6. The wrench socket as claimed in claim 1, wherein the side surface further defines a first end and a second end, wherein a dividing line is defined between the first end and the second end, and each of the plurality of groove portions starts from the first end and terminates at the dividing line or terminates before the dividing line.

7. The wrench socket as claimed in claim 1, wherein each of the plurality of groove portions is formed along the axis from a front end toward a rear end with a straight section and a tapered section connecting to the straight section, wherein the tapered section has the included angle.

8. The wrench socket as claimed in claim 1, wherein at least one annular groove portion is provided between any two of the plurality of groove portions on the side surface.

9. The wrench socket as claimed in claim 1, wherein at least one embossed portion is provided between any two of the plurality of groove portions on the side surface.
